(19) United States
(12) Patent Application Publication
(10) Pub. No.: US 2026/0227605 A1
(43) Pub. Date: Aug. 6, 2026

(54) OPTICAL IMAGING SYSTEM

(71) Applicant: SAMSUNG ELECTRO-MECHANICS CO., LTD., Suwon-si (KR)

(72) Inventors: Seon Ho RYU, Suwon-si (KR); Do Hyeong JANG, Suwon-si (KR); Ho Sik YOO, Suwon-si (KR); Tae Yeon LIM, Suwon-si (KR)

(73) Assignee: SAMSUNG ELECTRO-MECHANICS CO., LTD., Suwon-si (KR)

(21) Appl. No.: 19/406,358

(22) Filed: Dec. 2, 2025

(30) Foreign Application Priority Data
Feb. 6, 2025 (KR) 10-2025-0015019

(51) Int. Cl. G02B 13/00; G02B 3/00; G02B 9/62

(52) U.S. Cl. CPC G02B 13/0065; G02B 9/62; G02B 13/0045; G02B 2003/0093

(57) ABSTRACT

An optical imaging system includes a first lens group, an optical path folding member, and a second lens group, sequentially disposed from an object side. The first lens group includes a first lens having an image-side surface having a concave shape. The second lens group includes a second lens, a third lens having an image-side surface having a concave shape, a fourth lens having an image-side surface having a convex shape, and a fifth lens. The optical imaging system satisfies a conditional expression of 0.1<f/fG1<1.0. In the conditional expression, f is a focal length of the optical imaging system, and fG1 is a focal length of the first lens group.

### CROSS-REFERENCE TO RELATED APPLICATIONS

This application claims the benefit under 35 USC 119 (a) of Korean Patent Application No. 10-2025-0015019 filed on Feb. 6, 2025, in the Korean Intellectual Property Office, the entire disclosure of which is incorporated herein by reference for all purposes.

### BACKGROUND

### 1. Field

The present disclosure relates to an optical imaging system.

### 2. Description of the Background

A portable electronic device may include a camera module capable of capturing an image or recording a video. For example, the camera module may be mounted in a mobile phone, a laptop computer, or a game console. The portable electronic device may generally be manufactured to be thin or small in size to improve convenience of carrying thereof for a user. For example, the camera module mounted in the portable electronic device may include an optical path folding member configured to enable a change or modification of an optical path of an optical imaging system. The optical path folding member may reflect or refract the optical path of the optical imaging system extending in a first direction to another direction, intersecting the first direction, thereby achieving thinning and miniaturization of the camera module. However, the optical imaging system including the optical path folding member may have difficulty in implementing a low f number and high resolution.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, an optical path folding member, and a second lens group, sequentially disposed from an object side. The first lens group includes a first lens having an image-side surface having a concave shape. The second lens group includes a second lens, a third lens having an image-side surface having a concave shape, a fourth lens having an image-side surface having a convex shape, and a fifth lens, wherein the following conditional expression is satisfied: 0.1<f/fG1<1.0, where f is a focal length of the optical imaging system and fG1 is a focal length of the first lens group.

An object-side surface of the first lens may have a convex shape.

An object-side surface of the second lens may have a convex shape.

An object-side surface of the third lens may have a convex shape.

An object-side surface of the fourth lens may have a convex shape.

An object-side surface of the fifth lens may have a convex shape.

An object-side surface of the fifth lens may have a concave shape.

The second lens group may further include a sixth lens disposed on an image-side surface of the fifth lens.

An object-side surface of the sixth lens may have a concave shape.

In another general aspect, an optical imaging system includes a first lens having positive refractive power, a second lens having refractive power, a third lens having an image-side surface having a concave shape, a fourth lens having refractive power, a fifth lens having refractive power, and an optical path folding member disposed between the first lens and the second lens, the first to fifth lenses are sequentially disposed from an object side, and the following condition is satisfied: 3.0<D12/(T1+T2)<4.0, where D12 is a distance from an image-side surface of the first lens to an object-side surface of the second lens, T1 is a thickness of the first lens, and T2 is a thickness of the second lens.

Other features and aspects will be apparent from the following detailed description, the drawings, and the claims.

### BRIEF DESCRIPTION OF DRAWINGS

FIG. 1A is a block diagram illustrating an optical imaging system according to a first example embodiment of the present disclosure.

FIG. 1B is a modification of an optical imaging system according to a first example embodiment.

FIG. 1C is an enlarged view of a second optical path folding member illustrated in FIG. 1B.

FIG. 2 is an aberration diagram illustrating the optical imaging system illustrated in FIG. 1.

FIG. 3 is a block diagram illustrating an optical imaging system according to a second example embodiment of the present disclosure.

FIG. 4 is an aberration diagram illustrating the optical imaging system illustrated in FIG. 3.

FIG. 5 is a block diagram illustrating an optical imaging system according to a third example embodiment of the present disclosure.

FIG. 6 is an aberration diagram illustrating the optical imaging system illustrated in FIG. 5.

FIG. 7 is a block diagram illustrating an optical imaging system according to a fourth example embodiment of the present disclosure.

FIG. 8 is an aberration diagram illustrating the optical imaging system illustrated in FIG. 7.

FIG. 9 is a block diagram illustrating an optical imaging system according to a fifth example embodiment of the present disclosure.

FIG. 10 is an aberration diagram illustrating the optical imaging system illustrated in FIG. 9.

FIG. 11 is a block diagram illustrating an optical imaging system according to a sixth example embodiment of the present disclosure.

FIG. 12 is an aberration diagram illustrating the optical imaging system illustrated in FIG. 11.

FIG. 13 is a block diagram illustrating an optical imaging system according to a seventh example embodiment of the present disclosure.

FIG. 14 is an aberration diagram illustrating the optical imaging system illustrated in FIG. 13.

FIG. 15 is a block diagram illustrating an optical imaging system according to an eighth example embodiment of the present disclosure.

FIG. 16 is an aberration diagram illustrating the optical imaging system illustrated in FIG. 15.

FIG. 17 is a block diagram illustrating an optical imaging system according to a ninth example embodiment of the present disclosure.

FIG. 18 is an aberration diagram illustrating the optical imaging system illustrated in FIG. 17.

FIG. 19 is a block diagram illustrating an optical imaging system according to a ninth example embodiment of the present disclosure.

FIG. 20 is an aberration diagram illustrating the optical imaging system illustrated in FIG. 19.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may be to provide a telephoto optical imaging system for implementing high resolution while having a low f number.

As used herein, a frontmost lens or a first lens may refer to a lens closest to an object (or a subject), and a rearmost lens may refer to a lens closest to an image plane (or an image sensor). As used herein, a radius of curvature, a thickness, a TTL (a distance from an object-side surface of the first lens to the image plane), ImgHT (a height of the image plane), a focal length, and an air gap of a lens may be represented in millimeters (mm).

A thickness of a lens, a distance between lenses (air gap), and TTL may be measured based on an optical axis of an optical imaging system. In addition, in the description of a shape of a lens, one surface having a convex shape means that a paraxial region of the one surface is convex, and one surface having a concave shape means that a paraxial region of the one surface is concave. Accordingly, even when it is described that one surface of the lens has a convex shape, an edge portion of the lens may be concave. Similarly, even when it is described that one surface of the lens has a concave shape, an edge portion of the lens may be convex.

As used herein, an object-side surface of an optical path folding member may refer to a surface closer to an object to be imaged, among an incident surface (incident portion) and an exit surface (exit portion) of the optical path folding member, and an image-side surface of the optical path folding member may refer to a surface closer to an image plane (or an image sensor), among the incident surface (incident portion) and the exit surface (exit portion) of the optical path folding member.

An optical imaging system according to a first aspect of the present disclosure may include a first lens group, a first optical path folding member, and a second lens group, sequentially disposed from an object side. The first lens group and the second lens group may include one or more lenses. For example, the first lens group may include a foremost lens (or a first lens) disposed to be most adjacent to an object, and the second lens group may include a second lens, a third lens, a fourth lens, and a fifth lens. The optical imaging system according to the first aspect may include a lens having an image-side surface having a concave shape. For example, in the optical imaging system according to the first aspect, the image-side surfaces of both the first lens and the third lens may have a concave shape. The optical imaging system according to the first aspect may include a lens having an image-side surface having a convex shape. For example, in the optical imaging system according to the first aspect, an image-side surface of the fourth lens may have a convex shape. The optical imaging system according to the first aspect may satisfy a specific conditional expression. For example, the optical imaging system according to the first aspect may satisfy a conditional expression of 0.1<f/fG1<1.0. In the conditional expression, f may be a focal length of the optical imaging system, and fG1 may be a focal length of the first lens group.

An optical imaging system according to a second aspect of the present disclosure may include a first lens group, a first optical path folding member, a second lens group, and a second optical path folding member sequentially disposed from an object side. The optical imaging system according to the second aspect may satisfy a specific conditional expression. For example, the optical imaging system according to the second aspect may satisfy a conditional expression of 0.1<f/fG1<1.0. In the conditional expression, f may be a focal length of the optical imaging system, and fG1 may be a focal length of the first lens group.

In the optical imaging system according to the second aspect, the second optical path folding member may include a plurality of reflective surfaces. For example, the second optical path folding member may include two reflective surfaces.

An optical imaging system according to a third aspect of the present disclosure may include a first lens group, a first optical path folding member, a second lens group, and a second optical path folding member sequentially disposed from an object side. The optical imaging system according to the third aspect may satisfy a specific conditional expression. For example, the optical imaging system according to the third aspect may satisfy conditional expressions of 0.1<f/fG1<1.0 and 2.0<f number≤3.0. In the conditional expressions, f may be a focal length of the optical imaging system, and fG1 may be a focal length of the first lens group.

An optical imaging system according to a fourth aspect of the present disclosure may include a first lens group, a first optical path folding member, a second lens group, and a second optical path folding member sequentially disposed from an object side. In the optical imaging system according to the fourth aspect, the second optical path folding member may satisfy one or more of the following conditional expressions.

$$58 ° \leq θ1 \leq 62 ° \qquad ( Conditional Expression 1 )$$

$$28 ° \leq θ3 \leq 32 ° \qquad ( Conditional Expression 2 )$$

$$0.8 \leq SDP / ( ImgHT * 2 ) \leq 2. \qquad ( Conditional Expression 3 )$$

$$0.3 \leq HP / ( ImgHT * 2 ) \leq 1. \qquad ( Conditional Expression 4 )$$

In the above conditional expressions, θ1 may be an angle between an incident surface and a first reflective surface of the second optical path folding member, θ3 may be an angle between the first reflective surface and a second reflective surface of the second optical path folding member, SDP may be a length of the second optical path folding member in a first optical axis direction, and HP may be a length of the second optical path folding member in a direction, intersecting a first optical axis.

Conditional Expressions 1 to 4 may be numerical ranges for optimizing a size of the second optical path folding member. As one example, a second optical path folding member, exceeding an upper limit of Conditional Expression 1 or falling below a lower limit of Conditional Expression 2, may make it difficult to achieve thinning of the optical imaging system (or a camera module including the optical imaging system). As another example, a second optical path folding member, falling below a lower limit of Conditional Expression 1 or exceeding an upper limit of Conditional Expression 2, may make it difficult to achieve miniaturization of the optical imaging system (or a camera module including the optical imaging system). As another example, a second optical path folding member, deviating from the numerical ranges of Conditional Expressions 3 and 4, may unnecessarily extend a focal length of the optical imaging system, making it difficult to achieve thinning and miniaturization of the optical imaging system.

An optical imaging system according to a fifth aspect of the present disclosure may include one or more of the features according to the first to fourth aspects, and may satisfy one or more of the following conditional expressions.

$$0.2 \leq EDL 1 / PID \leq 0.5 \qquad ( Conditional Expression 5 )$$

$$0.2 \leq EDL 2 / LPD \leq 0.5 \qquad ( Conditional Expression 6 )$$

$$0.1 \leq f / fG 1 \leq 1. \qquad ( Conditional Expression 7 )$$

$$0.5 \leq ( ( f number ) * f ) / fG 1 \leq 3. \qquad ( Conditional Expression 8 )$$

$$FOV / PID \leq 1.3 \qquad ( Conditional Expression 9 )$$

$$3. \leq f / ImgHT \qquad ( Conditional Expression 10 )$$

$$1. \leq LPD / ImgHT \leq 2.5 \qquad ( Conditional Expression 11 )$$

In the conditional expressions, EDL1 may be an effective diameter of an object-side surface of a lens (a foremost lens or a first lens) disposed to be most adjacent to an object in the first lens group, PID may be a distance from a reflective surface of the first optical path folding member to an image plane, EDL2 may be an effective diameter of an object-side surface of a lens disposed to be most adjacent to an object in the second lens group, LPD may be a distance from the object-side surface of the foremost lens to the reflective surface of the first optical path folding member, FOV may be an overall field of view of the optical imaging system, and ImgHT may be a height of the image plane.

Conditional Expressions 5 and 8 may be conditions for implementing an optical imaging system having a low f number. As one example, an optical imaging system, deviating the numerical ranges of Conditional Expressions 5 and 8, may have a foremost lens with an excessively small effective diameter or a first lens group with an excessively long focal length, making it difficult to implement an optical imaging system having a low f number.

Conditional Expressions 6, 7, and 11 may be conditions for achieving thinning and miniaturization of the optical imaging system. As one example, an optical imaging system, deviating from the numerical ranges of Conditional Expressions 6, 7, and 11, may have difficulty in achieving thinning and miniaturization due to sizes of lenses included in the first lens group or the second lens group.

Conditional Expressions 9 and 10 may be conditions for achieving miniaturization of the optical imaging system. As one example, an optical imaging system, deviating from the numerical ranges of Conditional Expressions 9 and 10, may have an excessively large focal length (f) or TTL, making it difficult to achieve miniaturization.

An optical imaging system according to a sixth aspect of the present disclosure may include one or more of the features according to the first to fifth aspects and may satisfy one or more of the following conditional expressions.

$$0.8 ° / mm < FOV / PID < 1.2 ° / mm$$

$$3.8 < f / ImgHT < 5.$$

$$1.2 < TTL / f < 1.6$$

$$0.4 < DG 12 / f < 0.6$$

$$0.2 < DG 12 / TTL < 0.4$$

$$- 5. < fG 1 / fR < - 0.2$$

In the above conditional expressions, TTL may be a distance from an object-side surface of a foremost lens (or a first lens) to an image plane, DG12 may be an air gap between a first lens group and a second lens group (a distance from an image-side surface of a lens in the first lens group most adjacent to the image plane to an object-side surface of a lens in the second lens group most adjacent to an object), and fR may be a focal length of a rearmost lens (a lens in the second lens group most adjacent to the image plane).

The above-described conditional expressions may be conditions for implementing telephoto characteristics of an optical imaging system and achieving miniaturization and thinning of the optical imaging system.

An optical imaging system according to a seventh aspect of the present disclosure may include a first lens, a second lens, a third lens, a fourth lens, and a fifth lens sequentially disposed from an object side. In addition, the optical imaging system according to the seventh aspect may further include first optical path folding member disposed between the first lens and the second lens. The optical imaging system according to the seventh aspect may include a lens having positive refractive power. For example, in the optical imaging system according to the seventh aspect, the first lens may have positive refractive power. The optical imaging system according to the seventh aspect may include a lens having an image-side surface having a concave shape. For example, in the optical imaging system according to the seventh aspect, the third lens may have an image-side surface having a concave shape. The optical imaging system according to the seventh aspect may satisfy a specific conditional expression. For example, the optical imaging system according to the seventh aspect may satisfy a conditional expression of 3.0<D12/(T1+T2)<4.0. In the conditional expression, D12 may be a distance from an image-side surface of the first lens to an object-side surface of the second lens, T1 may be a thickness of the first lens, and T2 may be a thickness of the second lens.

An optical imaging system according to an eighth aspect of the present disclosure may include a first lens, a second lens, a third lens, a fourth lens, and a fifth lens sequentially disposed from an object side, and may satisfy one or more of the following conditional expressions.

$$2. < f number \leq 3.$$

$$0.4 < TTL / f 1 < 1.$$

$$3. < f 1 / f 2 < 7.$$

$$- 1.6 < f 2 / f 3 < - 1.$$

$$2. < ( f 1 + f 3 ) / f 2 < 6.$$

In the above conditional expressions, f1 may be a focal length of the first lens, f2 may be a focal length of the second lens, and f3 may be a focal length of the third lens. The first lens to the third lens, satisfying the above-described conditional expressions, may be advantageous for implementing a telephoto optical imaging system having a low f number.

An optical imaging system according to a ninth aspect of the present disclosure may include a first lens, a second lens, a third lens, a fourth lens, and a fifth lens sequentially disposed from an object side, and may satisfy one or more of the following conditional expressions.

$$2. < R 1 / R 3 < 3.$$

$$0.8 < R 3 / R 6 < 1.6$$

$$2. < R 1 / R 6 < 3.$$

$$1. < R 1 / ( R 3 + R 6 ) < 1.4$$

$$3. < D 12 / ( T 1 + T 2 ) < 4.$$

In the above conditional expressions, R1 may be a radius of curvature of an object-side surface of the first lens, R3 may be a radius of curvature on an object-side surface of the second lens, R6 may be a radius of curvature on an image-side surface of the third lens, D12 may be a distance from the image-side surface of the first lens to the object-side surface of the second lens, T1 may be a thickness of the first lens, and T2 may be a thickness of the second lens. In the above-described conditional expressions, a conditional expression regarding radius of curvature may be a numerical limitation for improving an aberration of the optical imaging system. In addition, in the above-described conditional expressions, a conditional expression regarding lens thickness may be a numerical limitation for disposing a first optical path folding member between the first lens and the second lens.

An optical imaging system according to a tenth aspect of the present disclosure may include two or more of the features of the optical imaging systems according to the seventh to ninth aspects. As one example, the optical imaging system according to the tenth aspect may include the feature of the seventh aspect and the feature of the eighth aspect. As another example, the optical imaging system according to the tenth aspect may include the feature of the seventh aspect and the feature of the ninth aspect.

The optical imaging systems according to the seventh to tenth aspects may further include a sixth lens, as necessary. As one example, the optical imaging system according to the seventh aspect may further include a sixth lens disposed on an image side of the fifth lens.

The optical imaging systems according to the seventh to tenth aspects may further include a second optical path folding member, as necessary. As one example, the optical imaging system according to the seventh aspect may further include a second optical path folding member disposed on an image side of a rearmost lens (a lens disposed to be most adjacent to an image plane). The second optical path folding member may include a plurality of reflective surfaces. For example, the second optical path folding member may include two reflective surfaces.

The optical imaging systems according to the first to tenth aspects may include one or more lenses having the following features, as necessary. As one example, the optical imaging system according to the first aspect may include one of the first to sixth lenses having the following features. As another example, the optical imaging system according to the seventh aspect may include two or more of the first to sixth lenses having the following features. However, the optical imaging system according to the above-described aspects may not necessarily include a lens having the following features. Hereinafter, the features of the first to sixth lenses will be described.

The first lens may have refractive power. For example, the first lens may have positive refractive power. One surface of the first lens may have a convex shape. For example, the first lens may have an object-side surface having a convex shape. The first lens may have a spherical surface or an aspherical surface. For example, both surfaces of the first lens may be aspherical surfaces. The first lens may be formed of a material having high light transmittance and excellent processability. For example, the first lens may be formed of a plastic material. The first lens may have a predetermined refractive index. For example, the first lens may have a refractive index of 1.52 or more. The first lens may have a predetermined Abbe number. For example, the first lens may have an Abbe number of 50 or more. The first lens may have a focal length within a predetermined range. For example, the focal length of the first lens may be determined within a range of 32.0 mm to 62.0 mm.

The second lens may have refractive power. For example, the second lens may have positive refractive power. One surface of the second lens may have a convex shape. For example, the second lens may have an object-side surface having a convex shape. The second lens may have a spherical surface or an aspherical surface. For example, both surfaces of the second lens may be aspherical surfaces. The second lens may be formed of a material having high light transmittance and excellent processability. For example, the second lens may be formed of a plastic material. The second lens may have a predetermined refractive index. For example, the second lens may have a refractive index of 1.52 or more. The second lens may have a predetermined Abbe number. For example, the second lens may have an Abbe number of 50 or more. The second lens may have a focal length within a predetermined range. For example, the focal length of the second lens may be determined within a range of 7.0 mm to 12.0 mm.

The third lens may have refractive power. For example, the third lens may have negative refractive power. One surface of the third lens may have a convex shape. For example, the third lens may have an object-side surface having a convex shape. The third lens may have a spherical surface or an aspherical surface. For example, both surfaces of the third lens may be aspherical surfaces. The third lens may be formed of a material having high light transmittance and excellent processability. For example, the third lens may be formed of a plastic material. The third lens may have a predetermined refractive index. For example, the third lens may have a refractive index of 1.62 or more. The third lens may have a predetermined Abbe number. For example, the third lens may have an Abbe number of 20 or more. The third lens may have a focal length within a predetermined range. For example, the focal length of the third lens may be determined within a range of −10.0 mm to −6.0 mm.

The fourth lens may have refractive power. For example, the fourth lens may have positive refractive power. One surface of the fourth lens may have a convex shape. For example, the fourth lens may have an object-side surface having a convex shape. The fourth lens may have a spherical surface or an aspherical surface. For example, both surfaces of the fourth lens may be aspherical surfaces. The fourth lens may be formed of a material having high light transmittance and excellent processability. For example, the fourth lens may be formed of a plastic material. The fourth lens may have a predetermined refractive index. For example, the fourth lens may have a refractive index of 1.6 or more. The fourth lens may have a predetermined Abbe number. For example, the fourth lens may have an Abbe number of less than 30. The fourth lens may have a focal length within a predetermined range. For example, the focal length of the fourth lens may be determined within a range of 8.0 mm to 50 mm.

The fifth lens may have refractive power. For example, the fifth lens may have positive or negative refractive power. One surface of the fifth lens may have a concave shape. For example, the fifth lens may have an image-side surface having a concave shape. The fifth lens may have a spherical surface or an aspherical surface. For example, both surfaces of the fifth lens may be aspherical surfaces. The fifth lens may be formed of a material having high light transmittance and excellent processability. For example, the fifth lens may be formed of a plastic material. The fifth lens may have a predetermined refractive index. For example, the fifth lens may have a refractive index of 1.62 or more. The fifth lens may have a predetermined Abbe number. For example, the fifth lens may have an Abbe number of less than 30. The fifth lens may have a focal length within a predetermined range. For example, the focal length of the fifth lens may be greater than 18 mm or less than-10.0 mm.

The sixth lens may have refractive power. For example, the sixth lens may have negative refractive power. One surface of the sixth lens may have a concave shape. For example, the sixth lens may have an object-side surface having a concave shape. The sixth lens may have a spherical surface or an aspherical surface. For example, both surfaces of the sixth lens may be aspherical surfaces. The sixth lens may be formed of a material having high light transmittance and excellent processability. For example, the sixth lens may be formed of a plastic material. The sixth lens may have a predetermined refractive index. For example, the sixth lens may have a refractive index of 1.6 or more. The sixth lens may have a predetermined Abbe number. For example, the sixth lens may have an Abbe number of 20 or more. The sixth lens may have a focal length within a predetermined range. For example, the focal length of the sixth lens may be determined within a range of −24.0 mm to −8.0 mm.

An aspherical lens included in the optical imaging system may be represented by Equation 1.

$$Z = \frac{c {r}^{2}}{1 + \sqrt{1 - ( 1 + k ) {c}^{2} {r}^{2}}} + A {r}^{4} + B {r}^{6} + C {r}^{8} + D {r}^{10} + {Er}^{12} + F {r}^{14} + G {r}^{16} + … \qquad ( Equation 1 )$$

In Equation 1, c may be a reciprocal of a radius of curvature of a corresponding lens, k may be a conic constant, r may be a distance from an arbitrary point on an aspherical surface to an optical axis, A, B, C, D, E, F, and G may be aspherical constants, and Z (or SAG) may be a height in an optical axis direction from an arbitrary point on an aspherical surface to a vertex of the aspherical surface.

Hereinafter, an optical imaging system according to an example embodiment of the present disclosure will be described with reference to the drawings.

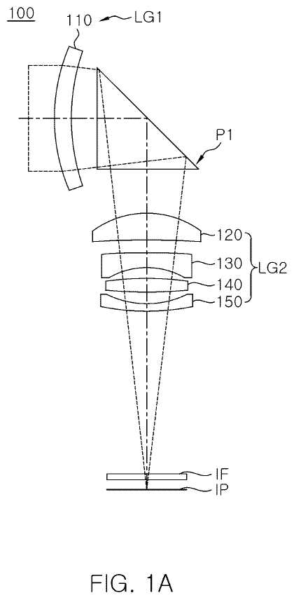

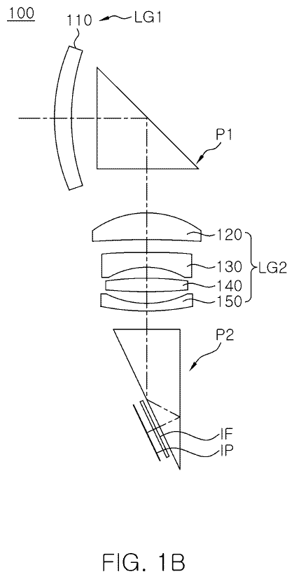

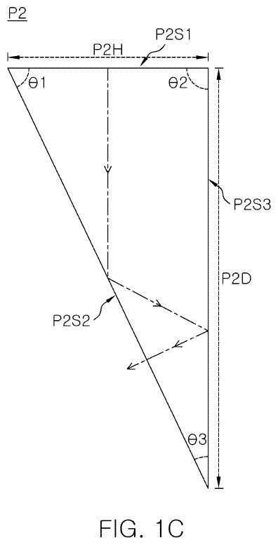

First, an optical imaging system according to a first example embodiment will be described with reference to FIGS. 1A, 1B, and 1C.

An optical imaging system 100 may include a plurality of lens groups. For example, the optical imaging system 100 may include a first lens group LG1 and a second lens group LG2 sequentially disposed from an object side. Each of the lens groups LG1 and LG2 may include one or more lenses. As one example, the first lens group LG1 may include a first lens 110, and the second lens group LG2 may include a second lens 120, a third lens 130, a fourth lens 140, and a fifth lens 150. However, the lenses included in the first lens group LG1 and the second lens group LG2 are not limited to the above-described forms.

The optical imaging system 100 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 100 may further include a second optical path folding member P2, as necessary. The second optical path folding member P2 may be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. The second optical path folding member P2 will be described in detail with reference to FIG. 1C.

The second optical path folding member P2 according to the present example embodiment may include an incident surface P2S1, a first reflective surface P2S2, a second reflective surface P2S3, and an exit surface P2S4. For reference, in the second optical path folding member P2 according to the present example embodiment, the first reflective surface P2S2 and the exit surface P2S4 may be formed on the same plane.

The incident surface P2S1, the first reflective surface P2S2, the second reflective surface P2S3, and the exit surface P2S4 may be sequentially formed. As one example, the incident surface P2S1, the first reflective surface P2S2, the second reflective surface P2S3, and the exit surface P2S4 may be sequentially formed from the object side. As another example, the incident surface P2S1, the first reflective surface P2S2, the second reflective surface P2S3, and the exit surface P2S4 may be sequentially formed along an optical path.

The first reflective surface P2S2 may be configured to have an angle less than 90 degrees relative to the incident surface P2S1. As a specific example, a first angle θ1 between the first reflective surface P2S2 and the incident surface P2S1 may be generally 60 degrees. However, the first angle θ1 is not limited to 60 degrees. For example, the first angle θ1 may vary within a range of 58 degrees to 62 degrees.

The second reflective surface P2S3 may be formed to oppose the first reflective surface P2S2, and may be configured to reflect light incident from the first reflective surface P2S2 toward the exit surface P2S4. The second reflective surface P2S3 may be configured to have a second angle θ2 of generally 90 degrees relative to the incident surface P2S1. For example, the second angle θ2 between the second reflective surface P2S3 and the incident surface P2S1 may be preferably 90 degrees. However, the second angle θ2 is not limited to 90 degrees.

The exit surface P2S4 may be formed to oppose the second reflective surface P2S3, and may be configured such that light reflected from the second reflective surface P2S3 exits. The exit surface P2S4 may be disposed to form a generally acute angle with the second reflective surface P2S3. For example, a third angle θ3 between the exit surface P2S4 and the second reflective surface P2S3 may be preferably generally 30 degrees. However, the third angle θ3 is not limited to 30 degrees. For example, the third angle θ3 may vary within a range of 28 degrees to 32 degrees.

The second optical path folding member P2 may have a predetermined size. For example, the incident surface P2S1 may have a size of P2H, and the second reflective surface P2S3 may have a size of P2D. P2H and P2D may have a predetermined size relationship with the image plane IP of the optical imaging system 100. As one example, P2H may be less than a diagonal length (2ImgHT) of the image plane IP, and P2D may be generally greater than the diagonal length (2ImgHT) of the image plane IP.

Hereinafter, optical characteristics of the lenses included in the first lens group LG1 and the second lens group LG2 will be described.

The first lens 110 may have positive refractive power, and may have an object-side surface having a convex shape and an image-side surface having a concave shape. The second lens 120 may have positive refractive power, and may have an object-side surface having a convex shape and an image-side surface having a concave shape. The third lens 130 may have negative refractive power, and may have an object-side surface having a convex shape and an image-side surface having a concave shape. The fourth lens 140 may have positive refractive power, and may have an object-side surface having a convex shape and an image-side surface having a convex shape. The fifth lens 150 may have negative refractive power, and may have an object-side surface having a concave shape and an image-side surface having a concave shape.

The optical imaging system 100 may further include a filter IF and an image plane IP. The image plane IP may be formed on an image sensor, and the filter IF may be disposed between the fifth lens 150 and the image plane IP.

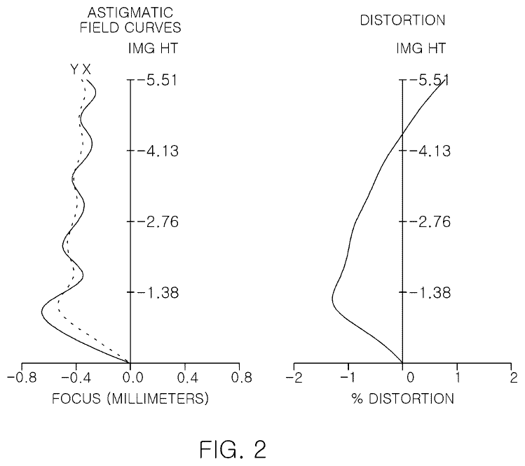

FIG. 2 illustrates an aberration curve of the optical imaging system according to the present example embodiment.

Table 1 and Table 2 indicate lens characteristics values and aspherical values of the optical imaging system according to the present example embodiment.

TABLE 1

| Surface | | | Thickness/ | Refractive | | Effective |
|---|---|---|---|---|---|---|
| number | Components | Radius of curvature | Distance | index | Abbe number | radius |
| S1 | First lens | 10.849 | 1.200 | 1.535 | 55.7 | 4.40 |
| S2 | | 18.385 | 1.400 | | | 4.22 |
| S3 | Prism | Infinity | 3.200 | 1.717 | 29.5 | 3.00 |
| S4 | | Infinity | 3.200 | 1.717 | 29.5 | 4.53 |
| S5 | | Infinity | 2.800 | | | 2.85 |
| S6 | Second lens | 5.148 | 1.660 | 1.535 | 55.7 | 3.30 |
| S7 | | 801.813 | 0.827 | | | 3.16 |
| S8 | Third lens | 39.184 | 0.838 | 1.639 | 23.5 | 2.74 |
| S9 | | 4.000 | 0.722 | | | 2.27 |
| S10 | Fourth lens | 22.800 | 0.789 | 1.671 | 19.2 | 2.49 |
| S11 | | −11.219 | 0.765 | | | 2.54 |
| S12 | Fifth lens | −10.381 | 0.500 | 1.639 | 23.5 | 2.58 |
| S13 | | 347.837 | 1.100 | | | 2.83 |
| S14 | Prism | Infinity | 5.200 | 1.717 | 29.5 | 3.33 |
| S15 | | Infinity | −4.200 | 1.717 | 29.5 | 7.21 |
| S16 | | Infinity | 2.100 | 1.717 | 29.5 | 5.23 |
| S17 | | Infinity | 0.500 | | | 5.00 |
| S18 | Filter | Infinity | 0.110 | 1.518 | 64.2 | 5.13 |
| S19 | | Infinity | 1.367 | | | 5.15 |
| S20 | Image plane | Infinity | −0.003 | | | 5.52 |

TABLE 2

| Surface | | | | | |
|---|---|---|---|---|---|
| number | S1 | S2 | S6 | S7 | S8 |
| K | 5.741E+00 | −7.138E+00 | −7.279E−02 | −3.690E−02 | −9.000E+01 |
| A | −5.809E−01 | −2.508E−01 | −2.988E−04 | −5.681E−02 | −1.445E−04 |
| B | −6.072E−02 | −5.911E−02 | 2.693E−05 | 6.127E−02 | −3.918E−05 |
| C | −3.003E−02 | −2.344E−02 | 1.429E−06 | −2.143E−02 | −4.195E−06 |
| D | −5.320E−03 | 5.589E−03 | 2.608E−07 | −9.129E−03 | −3.594E−07 |
| E | −2.895E−03 | 2.362E−03 | 5.827E−09 | −3.666E−03 | 8.391E−09 |
| F | 1.729E−03 | 5.381E−03 | 2.845E−10 | −7.548E−04 | 1.056E−09 |
| G | 1.913E−03 | 2.265E−03 | 2.204E−11 | 5.542E−04 | 5.816E−11 |
| H | 3.099E−03 | 3.151E−03 | 7.832E−13 | 9.473E−05 | 4.058E−13 |
| J | 2.320E−03 | 1.711E−03 | −7.828E−14 | −4.356E−04 | −3.294E−12 |
| L | 1.963E−03 | 1.937E−03 | | −8.160E−04 | |
| M | 9.698E−04 | 9.692E−04 | | −6.641E−04 | |
| N | 5.006E−04 | 8.634E−04 | | −3.934E−04 | |
| O | 8.665E−05 | 2.993E−04 | | −1.501E−04 | |
| P | 7.101E−06 | 2.252E−04 | | −1.896E−05 | |
| Surface | | | | | |
| number | S9 | S10 | S11 | S12 | S13 |
| K | 1.275E+00 | −5.596E+01 | 9.152E+00 | −4.696E+00 | 9.000E+01 |
| A | −6.040E−02 | 8.714E−05 | −6.072E−01 | 2.317E−03 | 5.507E−03 |
| B | −7.892E−02 | −1.348E−04 | 1.720E−01 | 3.552E−04 | 1.014E−05 |
| C | 1.383E−02 | −2.315E−05 | −8.193E−02 | 1.559E−05 | 5.593E−06 |
| D | 5.053E−03 | 3.752E−06 | 7.212E−02 | −4.651E−07 | −6.263E−07 |
| E | 3.054E−03 | −4.856E−09 | −4.915E−02 | 6.883E−08 | −3.546E−08 |
| F | −6.314E−04 | 1.795E−08 | −5.579E−03 | −1.933E−09 | −2.389E−09 |
| G | −2.121E−03 | 3.625E−09 | 4.061E−02 | −2.005E−09 | 2.342E−10 |
| H | −3.965E−03 | 2.945E−10 | 3.906E−03 | −2.327E−10 | 2.315E−11 |
| J | −3.672E−03 | −2.028E−20 | −2.777E−03 | −2.741E−20 | 2.788E−13 |
| L | −3.119E−03 | | 3.378E−03 | | |
| M | −1.955E−03 | | −2.317E−03 | | |
| N | −1.285E−03 | | −6.185E−04 | | |
| O | −5.792E−04 | | 2.910E−03 | | |
| P | −2.908E−04 | | 1.417E−03 | | |

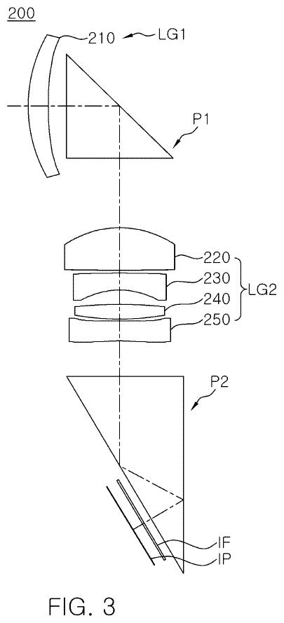

An optical imaging system according to a second example embodiment will be described with reference to FIG. 3.

An optical imaging system 200 may include a plurality of lens groups. For example, the optical imaging system 200 may include a first lens group LG1 and a second lens group LG2 sequentially disposed from an object side. Each of the lens groups LG1 and LG2 may include one or more lenses. As one example, the first lens group LG2 may include a first lens 210, and the second lens group LG2 may include a second lens 220, a third lens 230, a fourth lens 240, and a fifth lens 250. However, the lenses included in the first lens group LG1 and the second lens group LG2 are not limited to the above-described forms.

The optical imaging system 200 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 200 may further include a second optical path folding member P2, as necessary. The second optical path folding member P2 may be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or a similar to that illustrated in FIG. 1C.

Hereinafter, optical characteristics of the lenses included in the first lens group LG1 and the second lens group LG2 will be described.

The first lens 210 may have positive refractive power, and may have an object-side surface having a convex shape and an image-side surface having a concave shape. The second lens 220 may have positive refractive power, and may have an object-side surface having a convex shape and an image-side surface having a convex shape. The third lens 230 may have negative refractive power, and may have an object-side surface having a convex shape and an image-side surface having a concave shape. The fourth lens 240 may have positive refractive power, and may have an object-side surface having a convex shape and an image-side surface having a convex shape. The fifth lens 250 may have negative refractive power, and may have an object-side surface having a convex shape and an image-side surface having a concave shape.

The optical imaging system 200 may further include a filter IF and an image plane IP. The image plane IP may be formed on an image sensor, and the filter IF may be disposed between the fifth lens 250 and the image plane IP.

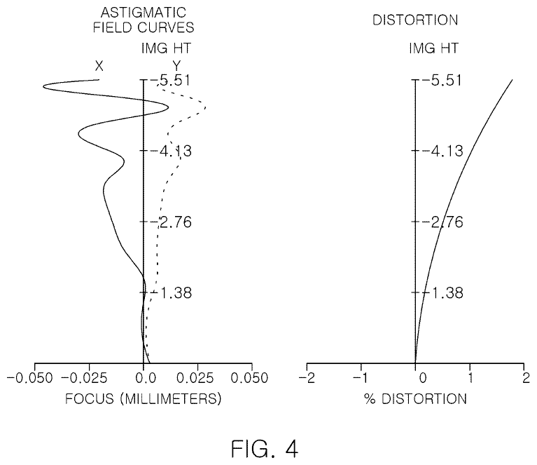

FIG. 4 illustrates an aberration curve of the optical imaging system according to the present example embodiment.

Table 3 and Table 4 indicate lens characteristics values and aspherical values of the optical imaging system according to the present example embodiment.

TABLE 3

| Surface | | | Thickness/ | Refractive | | Effective |
|---|---|---|---|---|---|---|
| number | Components | Radius of curvature | Distance | index | Abbe number | radius |
| S1 | First lens | 11.330 | 1.200 | 1.535 | 55.7 | 4.40 |
| S2 | | 18.766 | 1.100 | | | 4.20 |
| S3 | Prism | Infinity | 3.200 | 1.717 | 29.5 | 3.00 |
| S4 | | Infinity | 3.200 | 1.717 | 29.5 | 4.53 |
| S5 | | Infinity | 4.300 | | | 2.85 |
| S6 | Second lens | 5.632 | 2.621 | 1.535 | 55.7 | 3.30 |
| S7 | | −59.017 | 0.168 | | | 2.90 |
| S8 | Third lens | 74.842 | 1.055 | 1.639 | 23.5 | 2.79 |
| S9 | | 4.119 | 0.883 | | | 2.29 |
| S10 | Fourth lens | 26.519 | 0.909 | 1.671 | 19.2 | 2.60 |
| S11 | | −11.606 | 0.101 | | | 2.69 |
| S12 | Fifth lens | 109.966 | 1.225 | 1.614 | 25.9 | 2.72 |
| S13 | | 12.276 | 2.200 | | | 3.04 |
| S14 | Prism | Infinity | 5.500 | 1.834 | 37.3 | 3.71 |
| S15 | | Infinity | −4.400 | 1.834 | 37.3 | 7.45 |
| S16 | | Infinity | 2.200 | 1.834 | 37.3 | 5.45 |
| S17 | | Infinity | 0.500 | | | 5.21 |
| S18 | Filter | Infinity | 0.110 | 1.518 | 64.2 | 5.32 |
| S19 | | Infinity | 0.700 | | | 5.34 |
| S20 | Image plane | Infinity | 0.003 | | | 5.52 |

TABLE 4

| Surface | | | | | |
|---|---|---|---|---|---|
| number | S1 | S2 | S6 | S7 | S8 |
| K | 4.772E+00 | −9.001E+00 | 0.000E+00 | −3.690E−02 | −9.000E+01 |
| A | −6.135E−01 | −2.860E−01 | 5.318E−05 | 9.056E−02 | −1.123E−04 |
| B | −6.701E−02 | −5.816E−02 | −2.057E−05 | −2.781E−02 | 1.039E−05 |
| C | −1.750E−02 | −1.261E−02 | 3.154E−07 | 1.289E−02 | 2.503E−06 |
| D | −1.646E−03 | 1.755E−03 | −1.441E−07 | −8.310E−04 | 3.634E−07 |
| E | 1.143E−03 | 3.996E−03 | 0.000E+00 | 5.845E−04 | |
| F | 2.091E−03 | 4.046E−03 | 0.000E+00 | 2.159E−04 | |
| G | 1.544E−03 | 2.512E−03 | 0.000E+00 | 1.173E−04 | |
| H | 1.104E−03 | 1.329E−03 | 0.000E+00 | 5.459E−05 | |
| J | 5.528E−04 | 3.370E−04 | 0.000E+00 | 2.227E−05 | |
| L | 2.597E−04 | −8.661E−05 | | | |
| N | 3.494E−05 | −2.579E−04 | | | |
| N | −2.052E−05 | −1.833E−04 | | | |
| O | −3.922E−05 | −9.818E−05 | | | |
| P | −9.660E−06 | −1.562E−05 | | | |
| Surface | | | | | |
| number | S9 | S10 | S11 | S12 | S13 |
| K | 1.315E+00 | −3.676E+01 | 3.026E+00 | 0.000E+00 | 0.000E+00 |
| A | 5.258E−02 | −6.644E−04 | 1.688E−01 | −1.094E−03 | −4.456E−03 |
| B | 5.251E−02 | 5.631E−05 | −5.778E−02 | −3.061E−04 | 9.863E−05 |
| C | −4.968E−03 | 1.829E−05 | 3.251E−02 | −1.209E−05 | 6.814E−06 |
| D | −1.436E−03 | −3.756E−06 | −4.673E−02 | 1.099E−06 | 8.076E−08 |
| E | −1.986E−03 | 8.232E−08 | 4.206E−02 | −6.117E−09 | |
| F | −1.425E−03 | | 2.514E−03 | | |
| G | −6.853E−04 | | −2.921E−02 | | |
| H | −2.324E−04 | | −1.444E−02 | | |
| J | −5.206E−05 | | −1.953E−03 | | |
| L | | | | | |
| M | | | | | |
| N | | | | | |
| O | | | | | |
| P | | | | | |

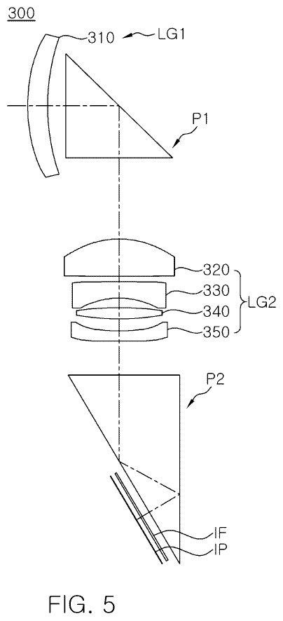

An optical imaging system according to a third example embodiment will be described with reference to FIG. 5.

An optical imaging system 300 may include a plurality of lens groups. For example, the optical imaging system 300 may include a first lens group LG1 and a second lens group LG2 sequentially disposed from an object side. Each of the lens groups LG1 and LG2 may include one or more lenses. As one example, the first lens group LG2 may include a first lens 310, and the second lens group LG2 may include a second lens 320, a third lens 330, a fourth lens 340, and a fifth lens 350. However, the lenses included in the first lens group LG1 and the second lens group LG2 are not limited to the above-described forms.

The optical imaging system 300 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 300 may further include a second optical path folding member P2, as necessary. The second optical path folding member P2 may be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or a similar to that illustrated in FIG. 1C.

Hereinafter, optical characteristics of the lenses included in the first lens group LG1 and the second lens group LG2 will be described.

The first lens 310 may have positive refractive power, and may have an object-side surface having a convex shape and an image-side surface having a concave shape. The second lens 320 may have positive refractive power, and may have an object-side surface having a convex shape and an image-side surface having a convex shape. The third lens 330 may have negative refractive power, and may have an object-side surface having a convex shape and an image-side surface having a concave shape. The fourth lens 340 may have positive refractive power, and may have an object-side surface having a convex shape and an image-side surface having a convex shape. The fifth lens 350 may have negative refractive power, and may have an object-side surface having a concave shape and an image-side surface having a concave shape.

The optical imaging system 300 may further include a filter IF and an image plane IP. The image plane IP may be formed on an image sensor, and the filter IF may be disposed between the fifth lens 250 and the image plane IP.

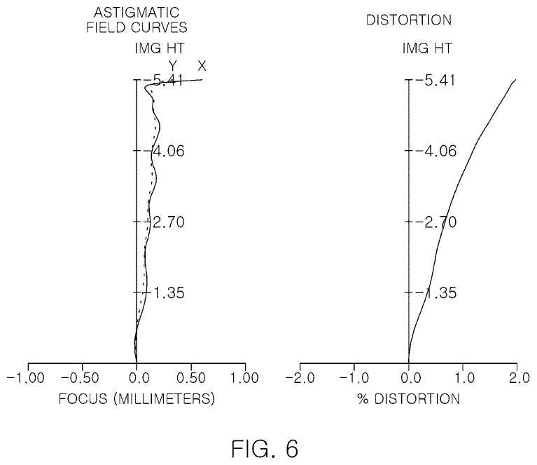

FIG. 6 illustrates an aberration curve of the optical imaging system according to the present example embodiment.

Table 5 and Table 6 indicate lens characteristics values and aspherical values of the optical imaging system according to the present example embodiment.

TABLE 5

| Surface | | | Thickness/ | Refractive | | Effective |
|---|---|---|---|---|---|---|
| number | Components | Radius of curvature | Distance | index | Abbe number | radius |
| S1 | First lens | 11.219 | 1.200 | 1.535 | 55.7 | 4.40 |
| S2 | | 18.040 | 1.100 | | | 4.21 |
| S3 | Prism | Infinity | 3.200 | 1.717 | 29.5 | 3.00 |
| S4 | | Infinity | 3.200 | 1.717 | 29.5 | 4.53 |
| S5 | | Infinity | 4.999 | | | 2.85 |
| S6 | Second lens | 5.276 | 2.300 | 1.535 | 55.7 | 3.30 |
| S7 | | −95.991 | 0.320 | | | 2.99 |
| S8 | Third lens | 66.714 | 1.009 | 1.639 | 23.5 | 2.79 |
| S9 | | 4.017 | 0.602 | | | 2.29 |
| S10 | Fourth lens | 23.333 | 0.686 | 1.671 | 19.2 | 2.51 |
| S11 | | −9.355 | 0.738 | | | 2.54 |
| S12 | Fifth lens | −11.882 | 0.629 | 1.639 | 23.5 | 2.56 |
| S13 | | 52.027 | 2.100 | | | 2.81 |
| S14 | Prism | Infinity | 5.300 | 1.717 | 29.5 | 3.37 |
| S15 | | Infinity | −4.200 | 1.717 | 29.5 | 7.37 |
| S16 | | Infinity | 2.100 | 1.717 | 29.5 | 5.42 |
| S17 | | Infinity | 0.500 | | | 5.15 |
| S18 | Filter | Infinity | 0.110 | 1.518 | 64.2 | 5.30 |
| S19 | | Infinity | 0.300 | | | 5.32 |
| S20 | Image plane | Infinity | 0.003 | | | 5.41 |

TABLE 6

| Surface | | | | | |
|---|---|---|---|---|---|
| number | S1 | S2 | S6 | S7 | S8 |
| K | −5.123E+00 | 7.749E+00 | −1.699E−03 | 3.690E−02 | 9.000E+01 |
| A | 5.974E−01 | 2.697E−01 | 1.762E−04 | 6.588E−02 | 3.650E−05 |
| B | 4.707E−02 | 4.795E−02 | −3.114E−05 | −4.373E−02 | 2.295E−05 |
| C | 3.073E−02 | 2.541E−02 | −9.898E−07 | 2.076E−02 | 3.006E−06 |
| D | 3.733E−03 | −2.601E−03 | −1.851E−07 | 3.324E−03 | 3.302E−07 |
| E | 3.666E−03 | −1.429E−03 | 1.037E−09 | 2.151E−03 | −3.034E−09 |
| F | −3.210E−03 | −6.108E−03 | 1.261E−10 | 4.590E−04 | −2.861E−10 |
| G | −2.467E−03 | −2.778E−03 | 4.271E−12 | −1.473E−04 | −2.517E−11 |
| H | −4.167E−03 | −2.945E−03 | −9.980E−13 | 7.217E−04 | −2.361E−12 |
| J | −2.440E−03 | −6.012E−04 | −1.547E−13 | 1.513E−03 | 3.596E−13 |
| L | −2.167E−03 | −7.824E−04 | | 1.982E−03 | |
| M | −8.004E−04 | −1.351E−05 | | 1.628E−03 | |
| N | −5.101E−04 | −3.943E−04 | | 1.078E−03 | |
| O | −5.066E−05 | −1.219E−04 | | 4.557E−04 | |
| P | −5.719E−05 | −1.868E−04 | | 1.434E−04 | |
| Surface | | | | | |
| number | S9 | S10 | S11 | S12 | S13 |
| K | −1.363E+00 | 4.891E+01 | −4.801E+00 | 3.066E+00 | −9.000E+01 |
| A | 4.749E−02 | −3.263E−04 | 3.238E−01 | −2.143E−03 | −4.831E−03 |
| B | 7.260E−02 | 9.155E−05 | −1.054E−01 | −3.528E−04 | 3.714E−05 |
| C | −1.369E−02 | 2.003E−05 | 5.691E−02 | −1.582E−05 | −5.906E−06 |
| D | −5.902E−03 | −3.611E−06 | −6.165E−02 | 5.404E−07 | 3.254E−07 |
| E | −1.625E−03 | 6.955E−08 | 4.938E−02 | −4.608E−08 | 1.233E−08 |
| F | 5.597E−04 | −6.514E−09 | 1.660E−04 | 1.054E−09 | 4.325E−10 |
| G | 2.176E−03 | −1.138E−09 | −3.518E−02 | 9.605E−10 | −1.287E−10 |
| H | 2.192E−03 | −4.710E−11 | −7.580E−03 | 1.910E−11 | −1.608E−11 |
| J | 1.618E−03 | 3.627E−21 | 5.786E−04 | 4.217E−21 | 3.561E−13 |
| L | 5.241E−04 | | −1.265E−03 | | |
| M | −9.808E−05 | | 9.016E−04 | | |
| N | −3.792E−04 | | 2.528E−04 | | |
| O | −2.722E−04 | | −6.391E−04 | | |
| P | −1.333E−04 | | −1.787E−04 | | |

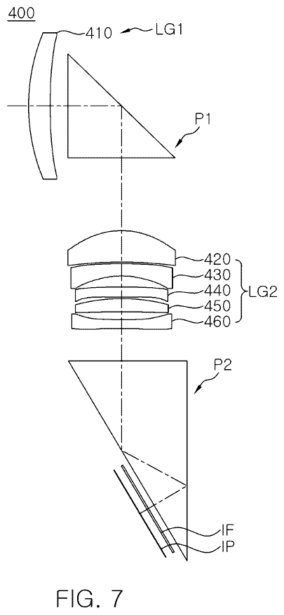

An optical imaging system according to a fourth example embodiment will be described with reference to FIG. 7.

An optical imaging system 400 may include a plurality of lens groups. For example, the optical imaging system 400 may include a first lens group LG1 and a second lens group LG2 sequentially disposed from an object side. Each of the lens groups LG1 and LG2 may include one or more lenses. As one example, the first lens group LG2 may include a first lens 410, and the second lens group LG2 may include a second lens 420, a third lens 430, a fourth lens 440, a fifth lens 450, and a sixth lens 460. However, the lenses included in the first lens group LG1 and the second lens group LG2 are not limited to the above-described forms.

The optical imaging system 400 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 400 may further include a second optical path folding member P2, as necessary. The second optical path folding member P2 may be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or a similar to that illustrated in FIG. 1C.

Hereinafter, optical characteristics of the lenses included in the first lens group LG1 and the second lens group LG2 will be described.

The first lens 410 may have positive refractive power, and may have an object-side surface having a convex shape and an image-side surface having a concave shape. The second lens 420 may have positive refractive power, and may have an object-side surface having a convex shape and an image-side surface having a convex shape. The third lens 430 may have negative refractive power, and may have an object-side surface having a convex shape and an image-side surface having a concave shape. The fourth lens 440 may have positive refractive power, and may have an object-side surface having a convex shape and an image-side surface having a convex shape. The fifth lens 450 may have positive refractive power, and may have an object-side surface having a convex shape and an image-side surface having a concave shape. The sixth lens 460 may have negative refractive power, and may have an object-side surface having a concave shape and an image-side surface having a concave shape.

The optical imaging system 400 may further include a filter IF and an image plane IP. The image plane IP may be formed on an image sensor, and the filter IF may be disposed between the sixth lens 460 and the image plane IP.

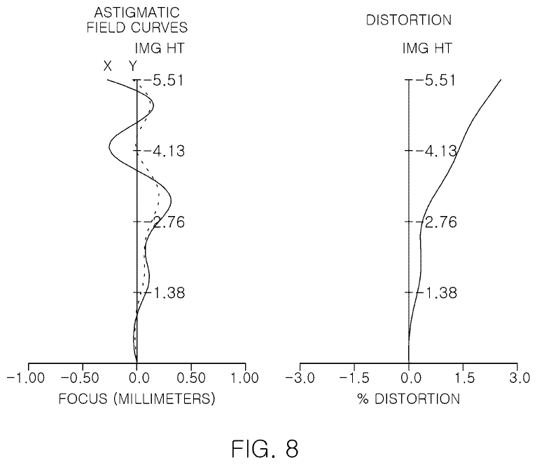

FIG. 8 illustrates an aberration curve of the optical imaging system according to the present example embodiment.

Table 7 and Table 8 indicate lens characteristics values and aspherical values of the optical imaging system according to the present example embodiment.

TABLE 7

| Surface | | | Thickness/ | Refractive | | Effective |
|---|---|---|---|---|---|---|
| number | Components | Radius of curvature | Distance | index | Abbe number | radius |
| S1 | First lens | 12.777 | 1.300 | 1.535 | 55.7 | 4.30 |
| S2 | | 27.460 | 1.100 | | | 4.17 |
| S3 | Prism | Infinity | 3.200 | 1.717 | 29.5 | 3.00 |
| S4 | | Infinity | 3.200 | 1.717 | 29.5 | 4.52 |
| S5 | | Infinity | 4.500 | | | 2.85 |
| S6 | Second lens | 4.666 | 1.923 | 1.535 | 55.7 | 3.21 |
| S7 | | 18.070 | 0.101 | | | 3.08 |
| S8 | Third lens | 32.038 | 0.752 | 1.639 | 23.5 | 3.06 |
| S9 | | 4.877 | 0.682 | | | 2.76 |
| S10 | Fourth lens | 31.759 | 0.626 | 1.614 | 25.9 | 2.77 |
| S11 | | −61.086 | 0.100 | | | 2.71 |
| S12 | Fifth lens | 11.641 | 0.806 | 1.671 | 19.2 | 2.76 |
| S13 | | 58.175 | 0.492 | | | 2.78 |
| S14 | Sixth lens | −20.151 | 0.536 | 1.614 | 25.9 | 2.78 |
| S15 | | 21.527 | 2.000 | | | 3.00 |
| S16 | Prism | Infinity | 5.504 | 1.834 | 37.3 | 3.48 |
| S17 | | Infinity | −4.538 | 1.834 | 37.3 | 7.45 |
| S18 | | Infinity | 2.269 | 1.834 | 37.3 | 5.49 |
| S19 | | Infinity | 0.400 | | | 5.26 |
| S20 | Filter | Infinity | 0.110 | 1.518 | 64.2 | 5.37 |
| S21 | | Infinity | 0.500 | | | 5.39 |
| S22 | Image plane | Infinity | 0.003 | | | 5.53 |

TABLE 8

| Surface | | | | | | |
|---|---|---|---|---|---|---|
| number | S1 | S2 | S6 | S7 | S8 | S9 |
| K | −8.561E+00 | 1.232E+00 | 3.380E−03 | −3.444E+01 | 8.696E+01 | −1.572E+00 |
| A | 4.710E−01 | 1.372E−01 | 1.000E−06 | −9.294E−02 | 4.399E−02 | 4.391E−02 |
| B | 3.752E−02 | 4.734E−02 | −7.615E−06 | 1.595E−03 | 6.337E−03 | 6.454E−02 |
| C | 1.186E−02 | 8.506E−03 | −2.010E−06 | 6.753E−02 | −9.206E−05 | 3.783E−03 |
| D | 9.615E−03 | 6.648E−03 | −3.375E−07 | −4.281E−02 | −1.302E−03 | −3.657E−03 |
| E | 5.709E−03 | 2.101E−03 | −1.191E−08 | 2.448E−03 | 1.536E−03 | 1.584E−03 |
| F | 2.508E−03 | 1.026E−03 | −6.439E−10 | 1.828E−02 | 2.670E−05 | −9.999E−04 |
| G | −4.369E−03 | −2.329E−03 | −1.152E−11 | −1.917E−03 | −5.062E−04 | 1.855E−03 |
| H | −8.228E−03 | −3.442E−03 | 2.732E−12 | −1.227E−02 | 2.065E−04 | 2.938E−03 |
| J | −9.785E−03 | −4.233E−03 | −9.337E−14 | −3.754E−03 | −3.137E−05 | 1.464E−03 |
| L | −7.698E−03 | −3.197E−03 | | 4.732E−03 | 2.969E−05 | 2.787E−04 |
| M | −4.707E−03 | −2.083E−03 | | 5.823E−03 | −6.188E−05 | −7.995E−04 |
| N | −1.745E−03 | −6.717E−04 | | 2.378E−03 | 8.691E−06 | −6.514E−04 |
| O | −3.731E−04 | −1.767E−04 | | −1.247E−03 | 2.595E−05 | −5.146E−04 |
| P | 2.332E−04 | 2.009E−04 | | −1.316E−03 | −1.015E−05 | −1.443E−04 |
| Surface | | | | | | |
| number | S10 | S11 | S12 | S13 | S14 | S15 |
| K | 8.312E+01 | −9.000E+01 | −2.807E+01 | 9.144E−01 | −3.303E−01 | 3.418E+01 |
| A | −1.173E−03 | 2.832E−03 | 6.536E−01 | −9.647E−02 | −2.016E−01 | −3.117E−01 |
| B | 1.112E−04 | 2.560E−04 | −1.312E−01 | 5.472E−02 | 4.106E−03 | −7.617E−03 |
| C | 2.568E−05 | 8.307E−06 | 6.100E−02 | −1.890E−02 | 1.600E−02 | −2.262E−03 |
| D | −3.413E−06 | 1.331E−07 | −4.716E−02 | −2.193E−02 | −6.413E−03 | −2.347E−03 |
| E | −4.228E−08 | 1.492E−07 | 2.559E−02 | 4.540E−02 | 1.229E−03 | 2.262E−05 |
| F | 1.390E−08 | 1.246E−08 | −3.635E−03 | −1.871E−03 | −4.744E−04 | −3.314E−04 |
| G | 1.570E−09 | 1.567E−09 | −1.458E−02 | −1.455E−02 | −1.293E−05 | 4.522E−05 |
| H | 1.192E−10 | 3.153E−11 | −1.322E−02 | −3.132E−02 | 2.818E−03 | 7.009E−04 |
| J | 2.345E−13 | 1.308E−12 | 1.133E−02 | 7.758E−03 | 1.599E−03 | 1.676E−04 |
| L | | | −2.694E−03 | 2.154E−03 | 2.007E−03 | 5.768E−04 |
| M | | | 5.557E−03 | −5.233E−03 | 1.448E−03 | 3.844E−04 |
| N | | | −7.920E−04 | −3.459E−03 | 8.869E−04 | 2.275E−04 |
| O | | | −3.289E−03 | 3.816E−03 | 4.295E−04 | 1.833E−04 |
| F | | | 1.384E−03 | 5.991E−03 | 2.046E−04 | 6.459E−05 |

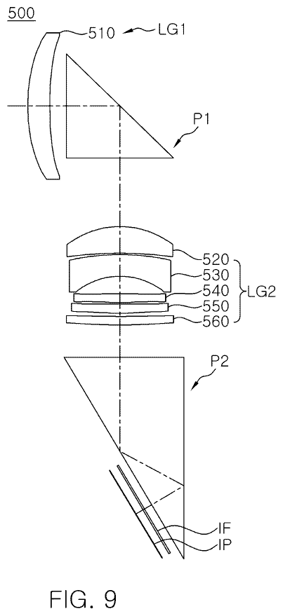

An optical imaging system according to a fifth example embodiment will be described with reference to FIG. 9.

An optical imaging system 500 may include a plurality of lens groups. For example, the optical imaging system 500 may include a first lens group LG1 and a second lens group LG2 sequentially disposed from an object side. Each of the lens groups LG1 and LG2 may include one or more lenses. As one example, the first lens group LG1 may include a first lens 510, and the second lens group LG2 may include a second lens 520, a third lens 530, a fourth lens 540, a fifth lens 550, and a sixth lens 560. However, the lenses included in the first lens group LG1 and the second lens group LG2 are not limited to the above-described forms.

The optical imaging system 500 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 500 may further include a second optical path folding member P2, as necessary. The second optical path folding member P2 may be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or similar to that illustrated in FIG. 1C.

Hereinafter, optical characteristics of the lenses included in the first lens group LG1 and the second lens group LG2 will be described.

The first lens 510 may have positive refractive power, and may have an object-side surface having a convex shape and an image-side surface having a concave shape. The second lens 520 may have positive refractive power, and may have an object-side surface having a convex shape and an image-side surface having a convex shape. The third lens 530 may have negative refractive power, and may have an object-side surface having a convex shape and an image-side surface having a concave shape. The fourth lens 540 may have positive refractive power, and may have an object-side surface having a convex shape and an image-side surface having a convex shape. The fifth lens 550 may have positive refractive power, and may have an object-side surface having a concave shape and an image-side surface having a convex shape. The sixth lens 560 may have negative refractive power, and may have an object-side surface having a concave shape and an image-side surface having a concave shape.

The optical imaging system 500 may further include a filter IF and an image plane IP. The image plane IP may be formed on an image sensor, and the filter IF may be disposed between the sixth lens 560 and the image plane IP.

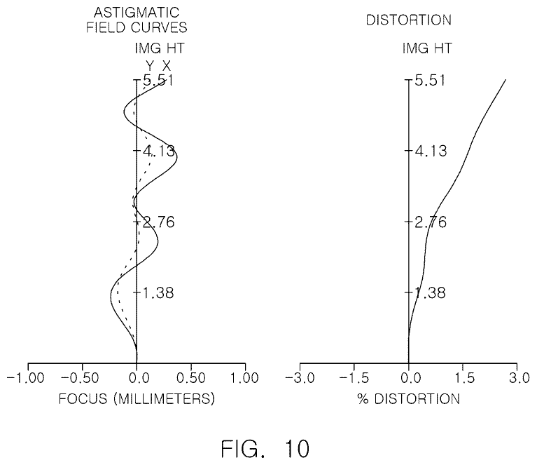

FIG. 10 illustrates an aberration curve of the optical imaging system according to the present example embodiment.

Table 9 and Table 10 indicate lens characteristics values and aspherical values of the optical imaging system according to the present example embodiment.

TABLE 9

| Surface | | | Thickness/ | Refractive | | Effective |
|---|---|---|---|---|---|---|
| number | Components | Radius of curvature | Distance | index | Abbe number | radius |
| S1 | First lens | 11.219 | 1.300 | 1.535 | 55.7 | 4.50 |
| S2 | | 21.526 | 1.000 | | | 4.30 |
| S3 | Prism | Infinity | 3.200 | 1.785 | 25.7 | 3.00 |
| S4 | | Infinity | 3.200 | 1.785 | 25.7 | 4.52 |
| S5 | | Infinity | 4.200 | | | 3.00 |
| S6 | Second lens | 4.935 | 1.634 | 1.535 | 55.7 | 3.15 |
| S7 | | 23.657 | 0.100 | | | 3.06 |
| S8 | Third lens | 14.491 | 1.326 | 1.614 | 25.9 | 3.02 |
| S9 | | 3.947 | 1.071 | | | 2.63 |
| S10 | Fourth lens | 140.191 | 0.531 | 1.544 | 56.0 | 2.65 |
| S11 | | −23.906 | 0.111 | | | 2.74 |
| S12 | Fifth lens | −96.267 | 0.545 | 1.671 | 19.2 | 2.76 |
| S13 | | −15.016 | 0.216 | | | 2.88 |
| S14 | Sixth lens | −35.031 | 0.500 | 1.614 | 25.9 | 2.98 |
| S15 | | 20.670 | 2.000 | | | 3.20 |
| S16 | Prism | Infinity | 5.767 | 1.834 | 37.3 | 3.90 |
| S17 | | Infinity | −4.400 | 1.834 | 37.3 | 7.00 |
| S18 | | Infinity | 2.200 | 1.834 | 37.3 | 5.12 |
| S19 | | Infinity | 0.500 | | | 5.28 |
| S20 | Filter | Infinity | 0.110 | 1.518 | 64.2 | 5.39 |
| S21 | | Infinity | 0.500 | | | 5.40 |
| S22 | Image plane | Infinity | 0.003 | | | 5.51 |

TABLE 10

| Surface | | | | | | |
|---|---|---|---|---|---|---|
| number | S1 | S2 | S6 | S7 | S8 | S9 |
| K | −5.490E+00 | 8.691E+00 | 3.147E−03 | 1.305E−01 | 6.474E−02 | −7.106E−01 |
| A | 2.976E−01 | 8.504E−02 | 1.222E−04 | 3.840E−02 | −1.180E−04 | 2.783E−02 |
| B | 2.841E−02 | 3.245E−02 | −6.726E−06 | −1.940E−02 | 1.301E−05 | 1.545E−02 |
| C | 1.407E−03 | 1.829E−04 | −8.979E−07 | −6.452E−04 | 2.347E−06 | 2.574E−03 |
| D | 2.526E−03 | 2.951E−03 | −2.154E−07 | −3.026E−04 | 3.555E−07 | −1.549E−03 |
| E | −8.378E−04 | −1.035E−03 | −1.507E−09 | −1.950E−04 | −4.234E−09 | 1.683E−04 |
| F | 6.537E−04 | 7.978E−04 | −2.799E−10 | 1.242E−05 | −1.433E−10 | −4.856E−04 |
| G | −3.480E−04 | −4.558E−04 | −2.626E−11 | 7.070E−06 | −8.857E−12 | 1.609E−04 |
| H | 2.145E−04 | 2.690E−04 | −3.141E−12 | −1.729E−05 | −8.840E−12 | −9.911E−05 |
| J | −1.605E−04 | −2.156E−04 | 3.062E−14 | 6.206E−05 | −3.284E−13 | 2.758E−05 |
| L | 9.012E−05 | 1.319E−04 | | −8.492E−06 | | −1.783E−05 |
| M | −1.159E−04 | −1.179E−04 | | −4.299E−05 | | 2.963E−05 |
| N | 9.268E−05 | 1.353E−04 | | 8.034E−06 | | −4.562E−05 |
| O | −6.934E−05 | −4.984E−05 | | 1.104E−05 | | 3.297E−05 |
| P | 4.369E−05 | 6.957E−05 | | −3.400E−06 | | −7.688E−06 |
| Surface | | | | | | |
| number | S10 | S11 | S12 | S13 | S14 | S15 |
| K | 9.000E+01 | −5.784E+01 | 2.292E−13 | −4.109E−01 | −2.791E+01 | −8.912E+01 |
| A | −1.118E−03 | 1.890E−03 | 2.242E−02 | 2.894E−01 | 8.972E−02 | −2.533E−01 |
| B | 1.102E−04 | 1.273E−04 | −2.173E−02 | −1.443E−01 | −1.914E−02 | −3.204E−02 |
| C | 2.410E−05 | −5.211E−06 | −8.748E−04 | 4.156E−02 | −6.431E−03 | −9.776E−03 |
| D | −3.526E−06 | −1.111E−06 | −2.480E−03 | 2.167E−02 | −1.788E−03 | −2.996E−03 |
| E | −1.239E−07 | 7.053E−09 | −9.006E−04 | −1.432E−02 | −8.086E−04 | −1.042E−03 |
| F | 1.061E−09 | −2.130E−09 | −7.301E−04 | −1.107E−02 | −2.897E−05 | −1.917E−04 |
| G | −2.520E−10 | −9.668E−10 | 1.128E−04 | 6.867E−03 | 4.291E−05 | −1.361E−04 |
| H | −9.052E−11 | −2.203E−10 | −1.167E−04 | 5.047E−03 | −4.820E−05 | −6.725E−05 |
| J | −1.005E−12 | 3.363E−12 | −8.668E−05 | −6.238E−03 | 2.475E−05 | −6.984E−05 |
| L | | | 3.288E−05 | −5.863E−03 | −5.016E−05 | −9.118E−05 |
| M | | | −6.109E−06 | 3.576E−03 | 1.674E−05 | 3.291E−05 |
| N | | | 1.921E−05 | 8.052E−03 | 7.264E−06 | −9.508E−05 |
| O | | | 3.463E−06 | 5.726E−03 | 6.661E−08 | 2.197E−05 |
| P | | | −4.317E−06 | 1.971E−03 | −7.491E−06 | −1.499E−06 |

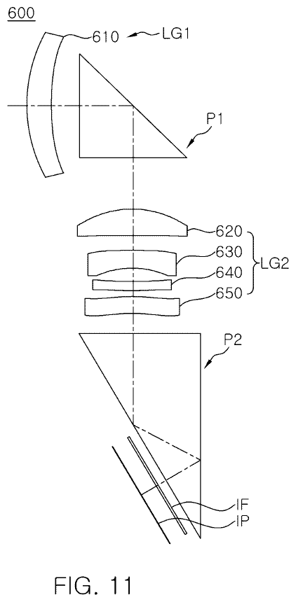

An optical imaging system according to a sixth example embodiment will be described with reference to FIG. 11.

An optical imaging system 600 may include a plurality of lens groups. For example, the optical imaging system 600 may include a first lens group LG1 and a second lens group LG2 sequentially disposed from an object side. Each of the lens groups LG1 and LG2 may include one or more lenses. As one example, the first lens group LG1 may include a first lens 610, and the second lens group LG2 may include a second lens 620, a third lens 630, a fourth lens 640, and a fifth lens 650. However, the lenses included in the first lens group LG1 and the second lens group LG2 are not limited to the above-described forms.

The optical imaging system 600 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 600 may further include a second be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or a similar to that illustrated in FIG. 1C.

Hereinafter, optical characteristics of the lenses included in the first lens group LG1 and the second lens group LG2 will be described.

The first lens 610 may have positive refractive power, and may have an object-side surface having a convex shape and an image-side surface having a concave shape. The second lens 620 may have positive refractive power, and may have an object-side surface having a convex shape and an image-side surface having a concave shape. The third lens 630 may have negative refractive power, and may have an object-side surface having a convex shape and an image-side surface having a concave shape. The fourth lens 640 may have positive refractive power, and may have an object-side surface having a concave shape and an image-side surface having a convex shape. The fifth lens 650 may have negative refractive power, and may have an object-side surface having a convex shape and an image-side surface having a concave shape.

The optical imaging system 600 may further include a filter IF and an image plane IP. The image plane IP may be formed on an image sensor, and the filter IF may be disposed between the fifth lens 650 and the image plane IP.

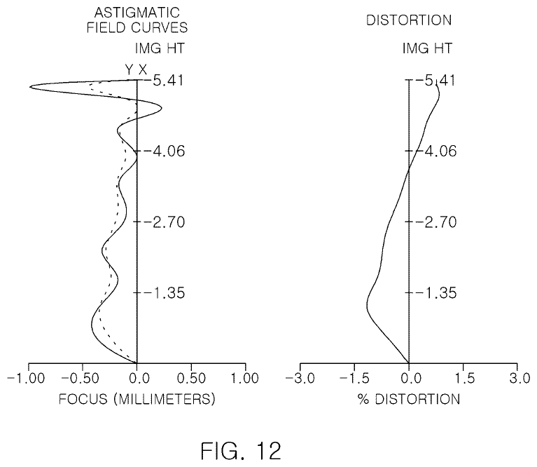

FIG. 12 illustrates an aberration curve of the optical imaging system according to the present example embodiment.

Table 11 and Table 12 indicate lens characteristics values and aspherical values of the optical imaging system according to the present example embodiment.

TABLE 11

| Surface | | | Thickness/ | Refractive | | Effective |
|---|---|---|---|---|---|---|
| number | Components | Radius of curvature | Distance | index | Abbe number | radius |
| S1 | First lens | 10.031 | 1.300 | 1.535 | 55.7 | 3.50 |
| S2 | | 15.102 | 1.500 | | | 3.32 |
| S3 | Prism | Infinity | 2.800 | 1.717 | 29.5 | 2.70 |
| S4 | | Infinity | 2.900 | 1.717 | 29.5 | 4.07 |
| S5 | | Infinity | 2.800 | | | 2.57 |
| S6 | Second lens | 4.974 | 1.440 | 1.535 | 55.7 | 2.81 |
| S7 | | 181.562 | 0.808 | | | 2.65 |
| S8 | Third lens | 23.060 | 0.982 | 1.614 | 25.9 | 2.31 |
| S9 | | 4.197 | 0.724 | | | 1.90 |
| S10 | Fourth lens | −31.164 | 0.500 | 1.671 | 19.2 | 1.96 |
| S11 | | −15.393 | 0.327 | | | 2.08 |
| S12 | Fifth lens | 10.516 | 0.924 | 1.614 | 25.9 | 2.27 |
| S13 | | 8.802 | 1.100 | | | 2.50 |
| S14 | Prism | Infinity | 4.900 | 1.717 | 29.5 | 2.83 |
| S15 | | Infinity | −4.200 | 1.717 | 29.5 | 6.87 |
| S16 | | Infinity | 2.100 | 1.717 | 29.5 | 5.11 |
| S17 | | Infinity | 0.500 | | | 4.90 |
| S18 | Filter | Infinity | 0.110 | 1.518 | 64.2 | 5.07 |
| S19 | | Infinity | 0.949 | | | 5.09 |
| S20 | Image plane | Infinity | −0.003 | | | 5.41 |

TABLE 12

| Surface | | | | | |
|---|---|---|---|---|---|
| number | S1 | S2 | S6 | S7 | S8 |
| K | −5.027E+00 | 8.129E+00 | 0.000E+00 | 3.690E−02 | 6.569E+01 |
| A | 5.379E−01 | 2.477E−01 | 3.219E−04 | 5.242E−02 | 2.064E−04 |
| B | 4.198E−02 | 3.637E−02 | −3.984E−05 | −1.850E−02 | 6.349E−05 |
| C | 1.507E−02 | 1.531E−02 | −1.436E−06 | 3.642E−03 | 7.585E−06 |
| D | 6.399E−03 | 3.240E−04 | −3.238E−07 | 2.157E−03 | 2.080E−06 |
| E | 1.545E−03 | −4.029E−03 | | 2.853E−03 | |
| F | −1.014E−03 | −5.563E−03 | | 2.257E−04 | |
| G | −2.489E−03 | −2.810E−03 | | −2.450E−03 | |
| H | −2.235E−03 | −2.572E−04 | | −1.856E−03 | |
| J | −1.454E−03 | 1.515E−03 | | −8.019E−04 | |
| L | −4.589E−04 | 1.402E−03 | | | |
| M | 1.464E−04 | 8.132E−04 | | | |
| N | 2.891E−04 | 6.706E−06 | | | |
| O | 2.748E−04 | −1.380E−04 | | | |
| P | 4.066E−05 | −2.276E−04 | | | |
| Surface | | | | | |
| number | S9 | S10 | S11 | S12 | S13 |
| K | −1.006E+00 | 3.775E+01 | −1.281E+01 | 0.000E+00 | 0.000E+00 |
| A | 7.203E−02 | −7.668E−04 | 3.463E−01 | −2.267E−03 | −6.583E−03 |
| B | 4.954E−02 | 5.375E−05 | −9.946E−02 | −5.219E−04 | 2.733E−05 |
| C | −2.155E−03 | 1.457E−05 | 4.818E−02 | −2.133E−05 | −2.024E−05 |
| D | −9.520E−04 | −1.544E−05 | −4.926E−02 | 3.121E−06 | 8.617E−07 |
| E | −1.977E−03 | −8.063E−07 | 3.872E−02 | −5.968E−08 | |
| F | −2.957E−03 | | 4.745E−03 | | |
| G | −3.228E−03 | | −2.997E−02 | | |
| H | −1.803E−03 | | −1.210E−02 | | |
| J | −6.273E−04 | | −8.146E−04 | | |
| L | | | | | |
| M | | | | | |
| N | | | | | |
| O | | | | | |
| P | | | | | |

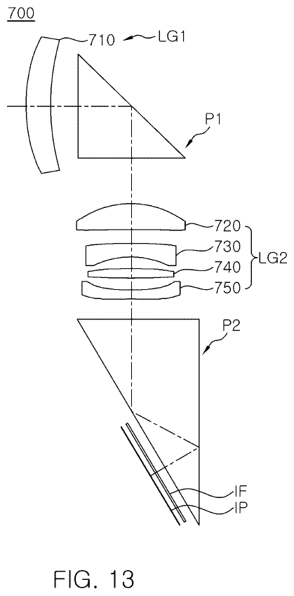

An optical imaging system according to a seventh example embodiment will be described with reference to FIG. 13.

An optical imaging system 700 may include a plurality of lens groups. For example, the optical imaging system 700 may include a first lens group LG1 and a second lens group LG2 sequentially disposed from an object side. Each of the lens groups LG1 and LG2 may include one or more lenses. As one example, the first lens group LG1 may include a first lens 710, and the second lens group LG2 may include a second lens 720, a third lens 730, a fourth lens 740, and a fifth lens 750. However, the lenses included in the first lens group LG1 and the second lens group LG2 are not limited to the above-described forms.

The optical imaging system 700 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 700 may further include a second be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or similar to that illustrated in FIG. 1C.

Hereinafter, optical characteristics of the lenses included in the first lens group LG1 and the second lens group LG2 will be described.

The first lens 710 may have positive refractive power, and may have an object-side surface having a convex shape and an image-side surface having a concave shape. The second lens 720 may have positive refractive power, and may have an object-side surface having a convex shape and an image-side surface having a convex shape. The third lens 730 may have negative refractive power, and may have an object-side surface having a convex shape and an image-side surface having a concave shape. The fourth lens 740 may have positive refractive power, and may have an object-side surface having a convex shape and an image-side surface having a convex shape. The fifth lens 750 may have negative refractive power, and may have an object-side surface having a concave shape and an image-side surface having a concave shape.

The optical imaging system 700 may further include a filter IF and an image plane IP. The image plane IP may be formed on an image sensor, and the filter IF may be disposed between the fifth lens 750 and the image plane IP.

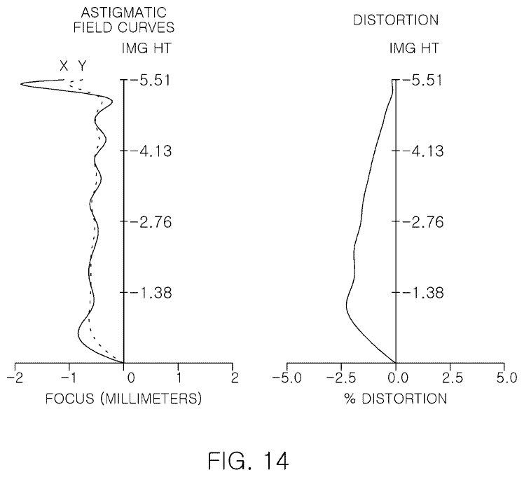

FIG. 14 illustrates an aberration curve of the optical imaging system according to the present example embodiment.

Table 13 and Table 14 indicate lens characteristics values and aspherical values of the optical imaging system according to the present example embodiment.

TABLE 13

| Surface | | | Thickness/ | Refractive | | Effective |
|---|---|---|---|---|---|---|
| number | Components | Radius of curvature | Distance | index | Abbe number | radius |
| S1 | First lens | 9.808 | 1.300 | 1.535 | 55.7 | 3.75 |
| S2 | | 17.344 | 1.500 | | | 3.57 |
| S3 | Prism | Infinity | 2.800 | 1.717 | 29.5 | 2.60 |
| S4 | | Infinity | 2.900 | 1.717 | 29.5 | 3.96 |
| S5 | | Infinity | 2.500 | | | 2.45 |
| S6 | Second lens | 4.782 | 1.429 | 1.535 | 55.7 | 2.89 |
| S7 | | −282.992 | 0.761 | | | 2.76 |
| S8 | Third lens | 38.520 | 0.723 | 1.639 | 23.5 | 2.45 |
| S9 | | 3.806 | 0.650 | | | 2.00 |
| S10 | Fourth lens | 22.797 | 0.534 | 1.671 | 19.2 | 2.28 |
| S11 | | −9.806 | 0.637 | | | 2.31 |
| S12 | Fifth lens | −12.346 | 0.500 | 1.639 | 23.5 | 2.35 |
| S13 | | 25.835 | 1.100 | | | 2.62 |
| S14 | Prism | Infinity | 5.000 | 1.717 | 29.5 | 3.04 |
| S15 | | Infinity | −4.200 | 1.717 | 29.5 | 7.40 |
| S16 | | Infinity | 2.100 | 1.717 | 29.5 | 5.47 |
| S17 | | Infinity | 0.500 | | | 5.21 |
| S18 | Filter | Infinity | 0.110 | 1.518 | 64.2 | 5.38 |
| S19 | | Infinity | 0.300 | | | 5.41 |
| S20 | Image plane | Infinity | −0.003 | | | 5.52 |

TABLE 14

| Surface | | | | | |
|---|---|---|---|---|---|
| number | S1 | S2 | S6 | S7 | S8 |
| K | −5.905E+00 | 8.349E+00 | 1.618E−01 | 3.690E−02 | 9.000E+01 |
| A | 5.172E−01 | 2.376E−01 | 5.559E−04 | 3.853E−02 | 2.320E−04 |
| B | 5.885E−02 | 5.059E−02 | −4.268E−05 | −5.719E−02 | 7.152E−05 |
| C | 2.297E−02 | 1.683E−02 | −3.083E−06 | 1.777E−02 | 8.705E−06 |
| D | 1.040E−02 | −1.428E−03 | −6.197E−07 | 8.919E−03 | 8.446E−07 |
| E | 2.104E−03 | −3.813E−03 | −6.292E−09 | 4.970E−03 | −1.022E−08 |
| F | −1.306E−03 | −5.126E−03 | −3.083E−10 | 2.119E−03 | −1.606E−09 |
| G | −3.950E−03 | −3.172E−03 | −1.918E−10 | 7.873E−04 | 4.032E−10 |
| H | −3.894E−03 | −2.432E−03 | −9.731E−12 | 8.362E−04 | 5.519E−11 |
| J | −3.384E−03 | −1.481E−03 | −9.928E−13 | 8.164E−04 | 1.980E−11 |
| L | −1.987E−03 | −1.415E−03 | | 5.470E−04 | |
| M | −1.140E−03 | −1.071E−03 | | 1.485E−04 | |
| N | −2.494E−04 | −7.870E−04 | | −6.616E−05 | |
| O | −7.086E−05 | −4.118E−04 | | −5.892E−05 | |
| P | 8.526E−05 | −1.703E−04 | | −1.380E−05 | |
| Surface | | | | | |
| number | S9 | S10 | S11 | S12 | S13 |
| K | −1.343E+00 | 6.168E+01 | −1.193E+01 | 6.866E+00 | −7.041E+01 |
| A | 4.651E−02 | 8.531E−05 | 6.622E−01 | −3.388E−03 | −7.409E−03 |
| B | 7.365E−02 | 2.673E−04 | −1.792E−01 | −6.410E−04 | −1.191E−05 |
| C | −1.344E−02 | 5.173E−05 | 7.947E−02 | −3.270E−05 | −1.328E−05 |
| D | −3.921E−03 | −9.672E−06 | −6.386E−02 | 9.452E−07 | 1.526E−06 |
| E | −6.116E−03 | −8.495E−08 | 4.165E−02 | −2.697E−07 | 7.870E−08 |
| F | −1.420E−03 | −1.199E−07 | 8.144E−03 | −7.173E−09 | 6.864E−10 |
| G | 1.550E−03 | −2.855E−08 | −4.106E−02 | 6.405E−09 | −1.868E−09 |
| H | 4.287E−03 | −1.562E−09 | −6.033E−03 | 8.558E−10 | −1.567E−10 |
| J | 3.178E−03 | 9.920E−20 | 4.137E−03 | −8.001E−12 | 1.213E−11 |
| L | 2.360E−03 | | −1.906E−03 | | |
| M | 1.306E−03 | | 3.642E−04 | | |
| N | 1.214E−03 | | −2.792E−03 | | |
| O | 6.414E−04 | | −4.807E−03 | | |
| P | 3.787E−04 | | −1.597E−03 | | |

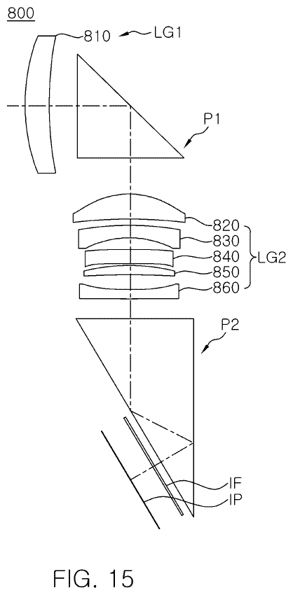

An optical imaging system according to an eighth example embodiment will be described with reference to FIG. 15.

An optical imaging system 800 may include a plurality of lens groups. For example, the optical imaging system 800 may include a first lens group LG1 and a second lens group LG2 sequentially disposed from an object side. Each of the lens groups LG1 and LG2 may include one or more lenses. As one example, the first lens group LG1 may include a first lens 810, and the second lens group LG2 may include a second lens 820, a third lens 830, a fourth lens 840, a fifth lens 850, and a sixth lens 860. However, the lenses included in the first lens group LG1 and the second lens group LG2 are not limited to the above-described forms.

The optical imaging system 800 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 800 may further include a second be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or similar to that illustrated in FIG. 1C.

Hereinafter, optical characteristics of the lenses included in the first lens group LG1 and the second lens group LG2 will be described.

The first lens 810 may have positive refractive power, and may have an object-side surface having a convex shape and an image-side surface having a concave shape. The second lens 820 may have positive refractive power, and may have an object-side surface having a convex shape and an image-side surface having a convex shape. The third lens 830 may have negative refractive power, and may have an object-side surface having a convex shape and an image-side surface having a concave shape. The fourth lens 840 may have positive refractive power, and may have an object-side surface having a convex shape and an image-side surface having a convex shape. The fifth lens 850 may have positive refractive power, and may have an object-side surface having a convex shape and an image-side surface having a concave shape. The sixth lens 860 may have negative refractive power, and may have an object-side surface having a concave shape and an image-side surface having a concave shape.

The optical imaging system 800 may further include a filter IF and an image plane IP. The image plane IP may be formed on an image sensor, and the filter IF may be disposed between the sixth lens 860 and the image plane IP.

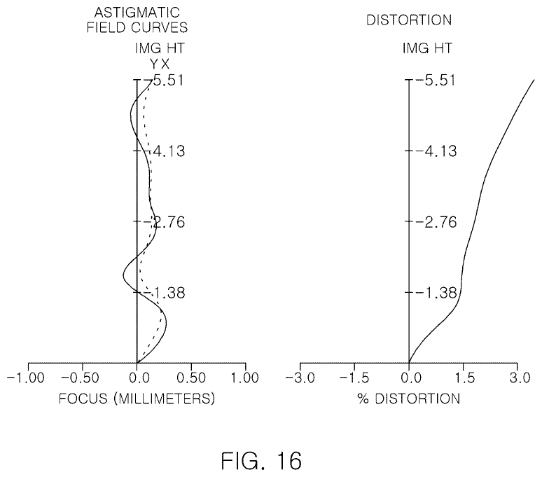

FIG. 16 illustrates an aberration curve of the optical imaging system according to the present example embodiment.

Table 15 and Table 16 indicate lens characteristics values and aspherical values of the optical imaging system according to the present example embodiment.

TABLE 15

| Surface | | | Thickness/ | Refractive | | Effective |
|---|---|---|---|---|---|---|
| number | Components | Radius of curvature | Distance | index | Abbe number | radius |
| S1 | First lens | 11.227 | 1.300 | 1.535 | 55.7 | 3.80 |
| S2 | | 22.289 | 1.500 | | | 3.67 |
| S3 | Prism | Infinity | 2.800 | 1.785 | 25.7 | 2.60 |
| S4 | | Infinity | 2.950 | 1.785 | 25.7 | 3.96 |
| S5 | | Infinity | 2.000 | | | 2.45 |
| S6 | Second lens | 4.212 | 1.379 | 1.535 | 55.7 | 3.01 |
| S7 | | 16.380 | 0.372 | | | 2.90 |
| S8 | Third lens | 28.743 | 0.665 | 1.639 | 23.5 | 2.73 |
| S9 | | 4.409 | 0.640 | | | 2.34 |
| S10 | Fourth lens | 30.606 | 0.785 | 1.614 | 25.9 | 2.36 |
| S11 | | −70.131 | 0.109 | | | 2.36 |
| S12 | Fifth lens | 10.071 | 0.505 | 1.671 | 19.2 | 2.43 |
| S13 | | 53.248 | 0.818 | | | 2.45 |
| S14 | Sixth lens | −18.222 | 0.524 | 1.614 | 25.9 | 2.50 |
| S15 | | 20.755 | 1.100 | | | 2.67 |
| S16 | Prism | Infinity | 4.950 | 1.834 | 37.3 | 3.21 |
| S17 | | Infinity | −4.000 | 1.834 | 37.3 | 7.17 |
| S18 | | Infinity | 2.000 | 1.834 | 37.3 | 5.19 |
| S19 | | Infinity | 0.400 | | | 4.93 |
| S20 | Filter | Infinity | 0.110 | 1.518 | 64.2 | 5.05 |
| S21 | | Infinity | 1.403 | | | 5.07 |
| S22 | Image plane | Infinity | 0.003 | | | 5.51 |

TABLE 16

| Surface | | | | | | |
|---|---|---|---|---|---|---|
| number | S1 | S2 | S6 | S7 | S8 | S9 |
| K | −7.712E+00 | −8.259E−01 | −2.462E−02 | −3.672E+01 | 8.863E+01 | −1.629E+00 |
| A | 4.226E−01 | 1.234E−01 | −1.513E−04 | −9.444E−02 | 4.045E−02 | 3.547E−02 |
| B | 3.059E−02 | 4.911E−02 | −3.293E−05 | 4.586E−03 | 4.062E−03 | 6.562E−02 |
| C | 1.550E−02 | 1.164E−02 | −6.356E−06 | 5.879E−02 | −8.417E−05 | −8.360E−04 |
| D | 4.474E−03 | 4.952E−03 | −1.059E−06 | −3.727E−02 | −4.589E−04 | −2.440E−03 |
| E | 5.432E−03 | 3.253E−03 | −4.527E−08 | 1.674E−03 | 2.089E−03 | 9.314E−04 |
| F | 7.651E−04 | 4.188E−04 | −2.624E−09 | 1.680E−02 | −3.540E−04 | −2.128E−03 |
| G | −3.474E−03 | −2.203E−03 | 1.632E−11 | 4.551E−04 | −8.076E−05 | 4.468E−04 |
| H | −7.955E−03 | −3.648E−03 | 2.161E−11 | −1.012E−02 | 1.277E−04 | 2.250E−04 |
| J | −8.962E−03 | −3.395E−03 | 1.587E−12 | −3.206E−03 | −1.543E−05 | −8.069E−04 |
| L | −7.940E−03 | −2.225E−03 | | 4.227E−03 | 7.777E−06 | −1.658E−03 |
| M | −5.213E−03 | −1.046E−03 | | 5.211E−03 | −1.791E−05 | −1.713E−03 |
| N | −2.798E−03 | −2.910E−04 | | 2.548E−03 | 2.353E−05 | −1.189E−03 |
| O | −1.018E−03 | −2.129E−05 | | 1.200E−04 | −3.083E−05 | −5.721E−04 |
| P | −2.443E−04 | 6.066E−05 | | −3.279E−04 | −1.190E−05 | −1.276E−04 |
| Surface | | | | | | |
| number | S10 | S11 | S12 | S13 | S14 | S15 |
| K | 8.907E+01 | −9.000E+01 | −2.952E+01 | 9.144E−01 | −3.303E−01 | 3.411E+01 |
| A | −1.550E−03 | 3.955E−03 | 5.410E−01 | −4.641E−02 | −1.798E−01 | −2.881E−01 |
| B | 1.994E−04 | 4.182E−04 | −1.043E−01 | 3.889E−02 | 1.644E−03 | −1.925E−03 |
| C | 5.446E−05 | 1.178E−05 | 4.775E−02 | −1.318E−02 | 1.486E−02 | 5.523E−03 |
| D | −8.770E−06 | −9.841E−07 | −3.785E−02 | −2.077E−02 | −4.137E−03 | −3.051E−03 |
| E | −1.553E−07 | 3.502E−07 | 2.023E−02 | 4.094E−02 | 5.422E−04 | 1.289E−03 |
| F | 4.694E−08 | 2.012E−08 | −1.983E−03 | −1.750E−03 | −1.888E−03 | −8.519E−04 |
| G | 6.940E−09 | 1.784E−09 | −1.329E−02 | −1.345E−02 | −5.953E−04 | 3.655E−04 |
| H | 4.720E−10 | −9.212E−10 | −1.311E−02 | −2.786E−02 | −4.457E−04 | −1.187E−04 |
| J | −6.637E−11 | 9.684E−12 | 1.211E−02 | 7.175E−03 | −5.477E−04 | −1.779E−05 |
| L | | | 1.768E−04 | 1.254E−03 | −2.026E−04 | −9.213E−05 |
| M | | | 5.999E−03 | −4.486E−03 | −8.732E−05 | −1.010E−05 |
| N | | | −1.342E−03 | −3.113E−03 | 5.130E−05 | −7.898E−05 |
| O | | | −1.736E−03 | 3.754E−03 | 6.215E−05 | −2.185E−06 |
| P | | | 8.708E−04 | 3.164E−03 | 7.646E−05 | −2.451E−05 |

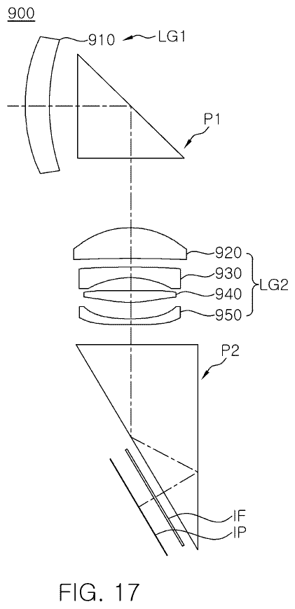

An optical imaging system according to a ninth example embodiment will be described with reference to FIG. 17.

An optical imaging system 900 may include a plurality of lens groups. For example, the optical imaging system 900 may include a first lens group LG1 and a second lens group LG2 sequentially disposed from an object side. Each of the lens groups LG1 and LG2 may include one or more lenses. As one example, the first lens group LG1 may include a first lens 910, and the second lens group LG2 may include a second lens 920, a third lens 930, a fourth lens 940, and a fifth lens 950. However, the lenses included in the first lens group LG1 and the second lens group LG2 are not limited to the above-described forms.

The optical imaging system 900 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 900 may further include a second optical path folding member P2, as necessary. The second optical path folding member P2 may be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or similar to that illustrated in FIG. 1C.

Hereinafter, optical characteristics of the lenses included in the first lens group LG1 and the second lens group LG2 will be described.

The first lens 910 may have positive refractive power, and may have an object-side surface having a convex shape and an image-side surface having a concave shape. The second lens 920 may have positive refractive power, and may have an object-side surface having a convex shape and an image-side surface having a convex shape. The third lens 930 may have negative refractive power, and may have an object-side surface having a convex shape and an image-side surface having a concave shape. The fourth lens 940 may have positive refractive power, and may have an object-side surface having a concave shape and an image-side surface having a convex shape. The fifth lens 950 may have negative refractive power, and may have an object-side surface having a concave shape and an image-side surface having a concave shape.

The optical imaging system 900 may further include a filter IF and an image plane IP. The image plane IP may be formed on an image sensor, and the filter IF may be disposed between the fifth lens 950 and the image plane IP.

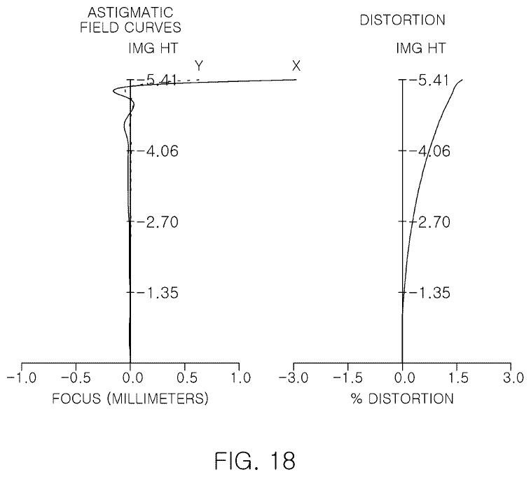

FIG. 18 illustrates an aberration curve of the optical imaging system according to the present example embodiment.

Table 17 and Table 18 indicate lens characteristics values and aspherical values of the optical imaging system according to the present example embodiment.

TABLE 17

| Surface | | | Thickness/ | Refractive | | Effective |
|---|---|---|---|---|---|---|
| number | Components | Radius of curvature | Distance | index | Abbe number | radius |
| S1 | First lens | 9.595 | 1.300 | 1.535 | 55.7 | 3.75 |
| S2 | | 13.543 | 1.500 | | | 3.57 |
| S3 | Prism | Infinity | 2.800 | 1.717 | 29.5 | 2.60 |
| S4 | | Infinity | 2.900 | 1.717 | 29.5 | 3.96 |
| S5 | | Infinity | 3.816 | | | 2.45 |
| S6 | Second lens | 4.334 | 1.686 | 1.535 | 55.7 | 2.93 |
| S7 | | 205.589 | 0.473 | | | 2.74 |
| S8 | Third lens | 49.002 | 0.593 | 1.639 | 23.5 | 2.60 |
| S9 | | 3.944 | 0.722 | | | 2.16 |
| S10 | Fourth lens | −100.000 | 0.627 | 1.671 | 19.2 | 2.39 |
| S11 | | −6.123 | 0.898 | | | 2.40 |
| S12 | Fifth lens | −9.236 | 0.302 | 1.639 | 23.5 | 2.40 |
| S13 | | 61.780 | 1.100 | | | 2.60 |
| S14 | Prism | Infinity | 5.000 | 1.717 | 29.5 | 2.97 |
| S15 | | Infinity | −4.200 | 1.717 | 29.5 | 7.05 |
| S16 | | Infinity | 2.100 | 1.717 | 29.5 | 5.16 |
| S17 | | Infinity | 0.500 | | | 4.91 |
| S18 | Filter | Infinity | 0.110 | 1.518 | 64.2 | 5.07 |
| S19 | | Infinity | 0.956 | | | 5.10 |
| S20 | Image plane | Infinity | 0.003 | | | 5.41 |

TABLE 18

| Surface | | | | | |
|---|---|---|---|---|---|
| number | S1 | S2 | S6 | S7 | S8 |
| K | −6.384E+00 | 5.467E+00 | 1.182E−01 | 3.690E−02 | −4.653E+01 |
| A | 4.977E−01 | 1.417E−01 | 2.929E−04 | 6.357E−02 | 9.871E−05 |
| B | 4.634E−02 | 8.685E−02 | −4.152E−05 | −8.624E−02 | 4.573E−05 |
| C | 2.468E−02 | 1.905E−02 | −2.518E−06 | 2.146E−02 | 4.944E−06 |
| D | 1.027E−02 | −2.900E−03 | −5.290E−07 | 7.469E−03 | 4.094E−07 |
| E | 3.441E−03 | −6.153E−03 | 5.230E−09 | 7.199E−03 | −4.903E−08 |
| F | −1.286E−03 | −4.242E−03 | 7.527E−10 | 3.176E−03 | −3.943E−09 |
| G | −3.610E−03 | −2.511E−03 | −1.397E−10 | 7.961E−04 | 3.276E−10 |
| H | −4.065E−03 | −2.222E−03 | −1.366E−11 | −1.594E−05 | 3.070E−11 |
| J | −3.317E−03 | −2.151E−03 | −2.528E−12 | −4.600E−05 | 5.870E−12 |
| L | −2.201E−03 | −1.652E−03 | | 8.358E−05 | |
| M | −1.178E−03 | −8.689E−04 | | 1.469E−04 | |
| N | −4.975E−04 | −3.415E−04 | | 1.231E−04 | |
| O | −1.432E−04 | −1.040E−04 | | 6.555E−05 | |
| P | −2.150E−05 | −3.430E−05 | | 1.912E−05 | |
| Surface | | | | | |
| number | S9 | S10 | S11 | S12 | S13 |
| K | −1.186E+00 | −9.000E+01 | −7.773E+00 | 6.017E+00 | −9.000E+01 |
| A | 6.348E−02 | 5.502E−04 | 4.895E−01 | −2.982E−03 | −8.095E−03 |
| B | 8.253E−02 | 3.380E−04 | −1.280E−01 | −6.600E−04 | 4.563E−06 |
| C | −1.374E−02 | 6.015E−05 | 5.268E−02 | −2.068E−05 | −1.231E−05 |
| D | −6.622E−03 | −8.226E−06 | −4.911E−02 | 2.443E−06 | 1.778E−06 |
| E | −4.365E−03 | 2.395E−07 | 3.589E−02 | −2.145E−07 | 9.767E−08 |
| F | −1.524E−03 | −4.802E−08 | 9.089E−03 | −1.647E−08 | −1.702E−09 |
| G | 1.430E−03 | −1.459E−08 | −3.950E−02 | 3.678E−09 | −2.566E−09 |
| H | 3.334E−03 | 4.851E−10 | −8.708E−03 | 1.956E−10 | −1.966E−10 |
| J | 3.642E−03 | 2.277E−10 | 5.753E−03 | −2.067E−10 | 3.063E−11 |
| L | 2.895E−03 | | −1.412E−03 | | |
| M | 1.791E−03 | | −1.476E−03 | | |
| N | 8.730E−04 | | −1.852E−03 | | |
| O | 3.095E−04 | | −2.772E−03 | | |
| P | 6.752E−05 | | −1.107E−03 | | |

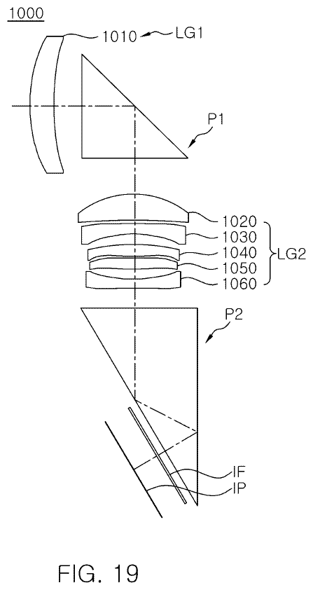

An optical imaging system according to a tenth example embodiment will be described with reference to FIG. 19.

An optical imaging system 1000 may include a plurality of lens groups. For example, the optical imaging system 1000 may include a first lens group LG1 and a second lens group LG2 sequentially disposed from an object side. Each of the lens groups LG1 and LG2 may include one or more lenses. As one example, the first lens group LG1 may include a first lens 1010, and the second lens group LG2 may include a second lens 1020, a third lens 1030, a fourth lens 1040, a fifth lens 1050, and a sixth lens 1060. However, the lenses included in the first lens group LG1 and the second lens group LG2 are not limited to the above-described forms.

The optical imaging system 1000 may further include a first optical path folding member P1. The first optical path folding member P1 may be configured in the form of a prism. However, the form of the first optical path folding member P1 is not limited to the prism. For example, the first optical path folding member P1 may be configured in the form of a reflective mirror. The first optical path folding member P1 may be disposed between lenses. For example, the first optical path folding member P1 may be disposed between the first lens group LG1 and the second lens group LG2.

As illustrated in FIG. 1B, the optical imaging system 1000 may further include a second optical path folding member P2, as necessary. The second optical path folding member P2 may be configured in the form of a prism. The second optical path folding member P2 may be disposed between a lens and an image plane IP. As a specific example, the second optical path folding member P2 may be disposed between the second lens group LG2 and the image plane. The second optical path folding member P2 may be configured to include two or more reflective surfaces. For example, the second optical path folding member P2 according to the present example embodiment may have a form the same as or similar to that illustrated in FIG. 1C.

Hereinafter, optical characteristics of the lenses included in the first lens group LG1 and the second lens group LG2 will be described.

The first lens 1010 may have positive refractive power, and may have an object-side surface having a convex shape and an image-side surface having a concave shape. The second lens 1020 may have positive refractive power, and may have an object-side surface having a convex shape and an image-side surface having a convex shape. The third lens 1030 may have negative refractive power, and may have an object-side surface having a convex shape and an image-side surface having a concave shape. The fourth lens 1040 may have positive refractive power, and may have an object-side surface having a convex shape and an image-side surface having a convex shape. The fifth lens 1050 may have positive refractive power, and may have an object-side surface having a convex shape and an image-side surface having a convex shape. The sixth lens 1060 may have negative refractive power, and may have an object-side surface having a concave shape and an image-side surface having a concave shape.

The optical imaging system 1000 may further include a filter IF and an image plane IP. The image plane IP may be formed on an image sensor, and the filter IF may be disposed between the sixth lens 1060 and the image plane IP.

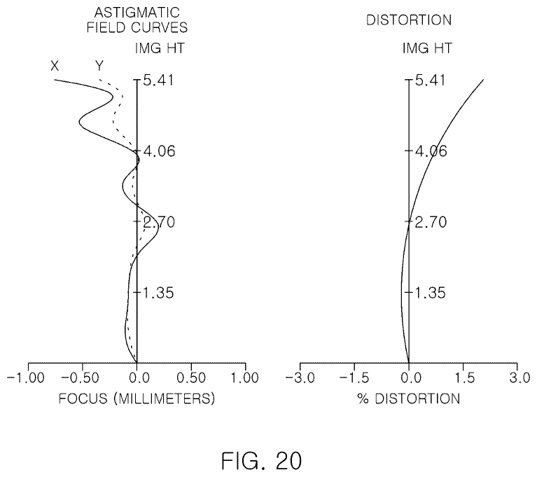

FIG. 20 illustrates an aberration curve of the optical imaging system according to the present example embodiment.

Table 19 and Table 20 indicate lens characteristics values and aspherical values of the optical imaging system according to the present example embodiment.

TABLE 19

| Surface | | | Thickness/ | Refractive | | Effective |
|---|---|---|---|---|---|---|
| number | Components | Radius of curvature | Distance | index | Abbe number | radius |
| S1 | First lens | 9.176 | 1.300 | 1.535 | 55.7 | 3.80 |
| S2 | | 16.173 | 1.500 | | | 3.67 |
| S3 | Prism | Infinity | 2.800 | 1.785 | 25.7 | 2.60 |
| S4 | | Infinity | 2.950 | 1.785 | 25.7 | 3.96 |
| S5 | | Infinity | 2.000 | | | 2.45 |
| S6 | Second lens | 4.000 | 1.438 | 1.535 | 55.7 | 3.01 |
| S7 | | 14.912 | 0.174 | | | 2.90 |
| S8 | Third lens | 46.225 | 0.587 | 1.639 | 23.5 | 2.73 |
| S9 | | 4.530 | 0.590 | | | 2.34 |
| S10 | Fourth lens | 31.364 | 0.639 | 1.614 | 25.9 | 2.36 |
| S11 | | −11.467 | 0.100 | | | 2.36 |
| S12 | Fifth lens | 48.613 | 0.619 | 1.671 | 19.2 | 2.43 |
| S13 | | −20.217 | 0.552 | | | 2.45 |
| S14 | Sixth lens | −6.693 | 0.500 | 1.614 | 25.9 | 2.50 |
| S15 | | 44.206 | 1.100 | | | 2.67 |
| S16 | Prism | Infinity | 4.950 | 1.834 | 37.3 | 3.21 |
| S17 | | Infinity | −4.000 | 1.834 | 37.3 | 7.17 |
| S18 | | Infinity | 2.000 | 1.834 | 37.3 | 5.19 |
| S19 | | Infinity | 0.422 | | | 4.93 |
| S20 | Filter | Infinity | 0.110 | 1.518 | 64.2 | 5.05 |
| S21 | | Infinity | 1.450 | | | 5.07 |
| S22 | Image plane | Infinity | 0.001 | | | 5.51 |

TABLE 20

| Surface | | | | | | |
|---|---|---|---|---|---|---|
| number | S1 | S2 | S6 | S7 | S8 | S9 |
| K | −4.937E+00 | 5.370E+00 | −1.419E−02 | −5.111E+01 | 8.343E+01 | −2.674E+00 |
| A | 5.374E−01 | 1.651E−01 | −1.841E−01 | −2.195E−01 | 4.478E−02 | −2.610E−02 |
| B | 2.660E−02 | 4.908E−02 | −8.527E−02 | 3.847E−05 | 3.314E−02 | 1.129E−01 |
| C | −8.935E−03 | 6.867E−03 | −1.822E−02 | 1.014E−01 | −9.952E−03 | −3.430E−02 |
| D | 1.325E−03 | 6.665E−04 | −5.388E−03 | −6.549E−02 | −6.780E−04 | 8.974E−03 |
| E | 9.890E−03 | 1.273E−03 | −5.951E−05 | −3.366E−03 | 1.100E−03 | 1.235E−02 |
| F | 8.080E−03 | 2.579E−03 | 7.323E−04 | 2.816E−02 | −2.357E−04 | 2.012E−03 |
| G | −2.784E−03 | 2.388E−03 | 1.125E−03 | 9.172E−03 | −6.667E−05 | −1.426E−03 |
| H | −1.254E−02 | 1.285E−03 | 4.023E−04 | −2.325E−02 | 1.999E−04 | −2.376E−03 |
| J | −1.653E−02 | 3.552E−05 | 2.227E−04 | −6.096E−03 | 1.630E−04 | −3.229E−03 |
| L | −1.394E−02 | −6.315E−04 | | 1.991E−02 | −1.096E−04 | −1.981E−03 |
| M | −8.651E−03 | −8.294E−04 | | 1.742E−02 | −2.330E−05 | −6.345E−04 |
| N | −3.666E−03 | −5.027E−04 | | −2.390E−03 | 5.047E−05 | 2.873E−04 |
| O | −9.722E−04 | −2.540E−04 | | −9.264E−03 | −2.667E−05 | 1.707E−04 |
| P | 4.654E−05 | 3.496E−05 | | −4.659E−03 | 5.160E−06 | 2.109E−04 |
| Surface | | | | | | |
| number | S10 | S11 | S12 | S13 | S14 | S15 |
| K | 7.629E+01 | −6.896E+01 | −2.424E+00 | 9.144E−01 | −3.302E−01 | 2.361E+01 |
| A | 1.116E−01 | 6.528E−03 | 1.172E+00 | 1.351E+00 | −1.598E−01 | −1.063E−01 |
| B | 4.879E−02 | 7.846E−04 | −2.580E−01 | −2.630E−01 | −7.455E−02 | −2.643E−02 |
| C | 1.643E−02 | 3.923E−05 | 1.039E−01 | 8.529E−02 | 4.185E−02 | 1.783E−03 |
| D | −1.298E−02 | −3.806E−07 | −5.057E−02 | −4.642E−02 | 2.633E−02 | 1.017E−03 |
| E | 3.873E−03 | 1.679E−07 | 7.687E−03 | 2.576E−02 | −5.301E−03 | −1.866E−03 |
| F | −8.927E−04 | −1.740E−08 | 3.194E−02 | 3.849E−02 | 3.366E−03 | 1.413E−03 |
| G | 3.599E−04 | 1.557E−09 | −5.606E−02 | −5.677E−02 | 1.214E−02 | −8.019E−04 |
| H | −2.920E−04 | −8.598E−11 | 2.280E−02 | 1.959E−02 | 2.950E−02 | 3.989E−04 |
| J | 6.475E−05 | 9.327E−12 | −5.756E−03 | −2.131E−02 | 2.423E−02 | −9.114E−05 |
| L | | | 1.083E−02 | 7.410E−04 | 1.495E−02 | |
| M | | | 8.366E−03 | −2. 169E−04 | 4.789E−03 | |
| N | | | 1.579E−03 | −9.543E−03 | 3.115E−04 | |
| O | | | −3.955E−03 | −1.490E−04 | −4.445E−04 | |
| P | | | 5.790E−03 | 1.599E−02 | −2. 165E−04 | |

Tables 21 to 25 indicate optical characteristic values and conditional expression values of the optical imaging systems according to the first to tenth example embodiments.

TABLE 21

| | First | Second | Third | Fourth | Fifth |
|---|---|---|---|---|---|
| | example | example | example | example | example |
| Remarks | embodiment | embodiment | embodiment | embodiment | embodiment |
| f | 22.700 | 22.700 | 22.710 | 22.710 | 22.710 |
| f1 | 46.870 | 50.596 | 52.252 | 43.325 | 41.953 |
| f2 | 9.677 | 9.748 | 9.423 | 11.197 | 11.312 |
| f3 | −7.038 | −6.861 | −6.732 | −9.102 | −9.279 |
| f4 | 11.311 | 12.148 | 10.037 | 34.119 | 37.586 |
| f5 | −15.766 | −22.614 | −15.080 | 21.538 | 26.443 |
| f6 | — | — | — | −16.869 | −21.100 |
| TTL | 32.474 | 35.575 | 34.596 | 34.644 | 34.413 |
| f number | 2.800 | 2.800 | 2.800 | 2.800 | 2.800 |
| ImgHT | 5.120 | 5.120 | 5.120 | 5.120 | 5.120 |
| FOV | 25.330 | 25.020 | 24.970 | 24.830 | 24.830 |
| fG1 | 46.870 | 50.596 | 52.252 | 43.325 | 41.953 |
| P2D | 11.610 | 12.084 | 11.744 | 12.182 | 12.387 |
| P2H | 6.686 | 7.000 | 6.754 | 7.106 | 7.054 |
| | Sixth | Seventh | Eighth | Ninth | Tenth |
| | example | example | example | example | example |
| Remarks | embodiment | embodiment | embodiment | embodiment | embodiment |
| f | 20.390 | 20.400 | 20.410 | 20.400 | 20.400 |
| f1 | 51.256 | 39.802 | 40.619 | 55.191 | 37.230 |
| f2 | 9.532 | 8.805 | 10.197 | 8.250 | 9.769 |
| f3 | −8.525 | −6.664 | −8.239 | −6.747 | −7.903 |
| f4 | 44.764 | 10.286 | 34.805 | 9.695 | 13.754 |
| f5 | −110.701 | −13.007 | 18.422 | −12.553 | 21.357 |
| f6 | — | — | −15.723 | — | −9.432 |
| TTL | 30.861 | 29.540 | 30.312 | 31.586 | 29.782 |
| f number | 3.000 | 2.800 | 2.900 | 2.900 | 2.800 |
| ImgHT | 5.120 | 5.120 | 5.120 | 5.120 | 5.120 |
| FOV | 28.000 | 28.260 | 27.120 | 27.810 | 27.790 |
| fG1 | 51.256 | 39.802 | 40.619 | 55.191 | 37.230 |
| P2D | 11.152 | 11.436 | 11.186 | 11.340 | 11.124 |
| P2H | 6.249 | 6.499 | 6.334 | 6.550 | 6.316 |

TABLE 22

| | First | Second | Third | Fourth | Fifth |
|---|---|---|---|---|---|
| Conditional | example | example | example | example | example |
| expression | embodiment | embodiment | embodiment | embodiment | embodiment |
| P2D/ | 1.1338 | 1.1801 | 1.1469 | 1.1896 | 1.2097 |
| (ImgHT*2) | | | | | |
| P2H/ | 0.6529 | 0.6836 | 0.6596 | 0.6939 | 0.6889 |
| (ImgHT*2) | | | | | |
| EDL1/PID | 0.3299 | 0.2926 | 0.3025 | 0.2961 | 0.3113 |
| EDL2/LPD | 1.1379 | 1.2000 | 1.2000 | 1.1459 | 1.1455 |
| f/fG1 | 0.4843 | 0.4486 | 0.4346 | 0.5242 | 0.5413 |
| (f number*f) | 1.3561 | 1.2562 | 1.2170 | 1.4677 | 1.5157 |
| /fG1 | | | | | |
| FOV/PID | 0.9496 | 0.8319 | 0.8582 | 0.8549 | 0.8588 |
| f/ImgHT | 4.4336 | 4.4336 | 4.4355 | 4.4355 | 4.4355 |
| LPD/ImgHT | 1.1328 | 1.0742 | 1.0742 | 1.0938 | 1.0742 |
| | Sixth | Seventh | Eighth | Ninth | Tenth |
| Conditional | example | example | example | example | example |
| expression | embodiment | embodiment | embodiment | embodiment | embodiment |
| P2D/ | 1.0891 | 1.1168 | 1.0924 | 1.1074 | 1.0863 |
| (ImgHT*2) | | | | | |
| P2H/ | 0.6103 | 0.6347 | 0.6186 | 0.6396 | 0.6168 |
| (ImgHT*2) | | | | | |
| EDL1/PID | 0.2771 | 0.3133 | 0.3075 | 0.2886 | 0.3143 |
| EDL2/LPD | 1.0037 | 1.0332 | 1.0766 | 1.0478 | 1.0766 |
| f/fG1 | 0.3978 | 0.5125 | 0.5025 | 0.3696 | 0.5479 |
| (f number*f) | 1.1934 | 1.4351 | 1.4572 | 1.0719 | 1.5342 |
| /fG1 | | | | | |
| FOV/PID | 1.1084 | 1.1804 | 1.0975 | 1.0702 | 1.1492 |
| f/ImgHT | 3.9824 | 3.9844 | 3.9863 | 3.9844 | 3.9844 |
| LPD/ImgHT | 1.0938 | 1.0938 | 1.0938 | 1.0938 | 1.0938 |

TABLE 23

| | First | Second | Third | Fourth | Fifth |
|---|---|---|---|---|---|
| Conditional | example | example | example | example | example |
| expression | embodiment | embodiment | embodiment | embodiment | embodiment |
| FOV/PID | 0.9496 | 0.8319 | 0.8582 | 0.8549 | 0.8588 |
| f/ImgHT | 4.4336 | 4.4336 | 4.4355 | 4.4355 | 4.4355 |
| TTL/f | 1.4306 | 1.5672 | 1.5234 | 1.5255 | 1.5153 |
| DG12/f | 0.4670 | 0.5198 | 0.5504 | 0.5284 | 0.5108 |
| DG12/TTL | 0.3264 | 0.3317 | 0.3613 | 0.3464 | 0.3371 |
| fG1/fR | −2.9729 | −2.2374 | −3.4650 | −2.5683 | −1.9883 |
| | Sixth | Seventh | Eighth | Ninth | Tenth |
| Conditional | example | example | example | example | example |
| expression | embodiment | embodiment | embodiment | embodiment | embodiment |
| FOV/PID | 1.1084 | 1.1804 | 1.0975 | 1.0702 | 1.1492 |
| f/ImgHT | 3.9824 | 3.9844 | 3.9863 | 3.9844 | 3.9844 |
| TTL/f | 1.5135 | 1.4480 | 1.4851 | 1.5483 | 1.4599 |
| DG12/f | 0.4904 | 0.4755 | 0.4532 | 0.5400 | 0.4534 |
| DG12/TTL | 0.3240 | 0.3284 | 0.3052 | 0.3488 | 0.3106 |
| fG1/fR | −0.4630 | −3.0601 | −2.5834 | −4.3966 | −3.9473 |

TABLE 24

| | First | Second | Third | Fourth | Fifth |
|---|---|---|---|---|---|
| Conditional | example | example | example | example | example |
| expression | embodiment | embodiment | embodiment | embodiment | embodiment |
| TTL/f1 | 0.6928 | 0.7031 | 0.6621 | 0.7996 | 0.8203 |
| f1/f2 | 4.8432 | 5.1904 | 5.5452 | 3.8694 | 3.7089 |
| f2/f3 | −1.3751 | −1.4208 | −1.3997 | −1.2302 | −1.2191 |
| (f1 + f3)/f2 | 4.1160 | 4.4866 | 4.8308 | 3.0565 | 2.8886 |
| | Sixth | Seventh | Eighth | Ninth | Tenth |
| Conditional | example | example | example | example | example |
| expression | embodiment | embodiment | embodiment | embodiment | embodiment |
| TTL/f1 | 0.6021 | 0.7422 | 0.7462 | 0.5723 | 0.7999 |
| f1/f2 | 5.3775 | 4.5204 | 3.9835 | 6.6894 | 3.8111 |
| f2/f3 | −1.1181 | −1.3213 | −1.2377 | −1.2229 | −1.2360 |
| (f1 + f3)/f2 | 4.4831 | 3.7636 | 3.1755 | 5.8717 | 3.0021 |

TABLE 25

| | First | Second | Third | Fourth | Fifth |
|---|---|---|---|---|---|
| Conditional | example | example | example | example | example |
| expression | embodiment | embodiment | embodiment | embodiment | embodiment |
| R1/R3 | 2.1074 | 2.0116 | 2.1263 | 2.7383 | 2.2734 |
| R3/R6 | 1.2868 | 1.3674 | 1.3133 | 0.9566 | 1.2503 |
| R1/R6 | 2.7119 | 2.7507 | 2.7925 | 2.6196 | 2.8424 |
| R1/(R3 + R6) | 1.1859 | 1.1619 | 1.2071 | 1.3388 | 1.2631 |
| D12/(T1 + T2) | 3.7068 | 3.0880 | 3.5712 | 3.7232 | 3.9541 |
| | Sixth | Seventh | Eighth | Ninth | Tenth |
| Conditional | example | example | example | example | example |
| expression | embodiment | embodiment | embodiment | embodiment | embodiment |
| R1/R3 | 2.0168 | 2.0511 | 2.6652 | 2.2141 | 2.2939 |
| R3/R6 | 1.1851 | 1.2563 | 0.9553 | 1.0988 | 0.8830 |
| R1/R6 | 2.3900 | 2.5768 | 2.5461 | 2.4330 | 2.0254 |
| R1/(R3 + R6) | 1.0938 | 1.1420 | 1.3021 | 1.1592 | 1.0756 |
| D12/(T1 + T2) | 3.6495 | 3.5547 | 3.4528 | 3.6894 | 3.3783 |

The present disclosure may provide a telephoto optical imaging system capable of implementing a low number while including an optical path folding member.

In addition, the present disclosure may provide a telephoto optical imaging system for implementing high resolution while including an optical path folding member.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group, an optical path folding member, and a second lens group, sequentially disposed from an object side,
wherein the first lens group comprises a first lens having an image-side surface having a concave shape,
wherein the second lens group comprises a second lens, a third lens having an image-side surface having a concave shape, a fourth lens having an image-side surface having a convex shape, and a fifth lens, and
wherein the following conditional expression is satisfied:
$$0.1 < f / fG 1 < 1. ,$$
where f is a focal length of the optical imaging system and fG1 is a focal length of the first lens group.

2. The optical imaging system of claim 1, wherein an object-side surface of the first lens has a convex shape.

3. The optical imaging system of claim 1, wherein an object-side surface of the second lens has a convex shape.

4. The optical imaging system of claim 1, wherein an object-side surface of the third lens has a convex shape.

5. The optical imaging system of claim 1, wherein an object-side surface of the fourth lens has a convex shape.

6. The optical imaging system of claim 1, wherein an object-side surface of the fifth lens has a convex shape.

7. The optical imaging system of claim 1, wherein an object-side surface of the fifth lens has a concave shape.

8. The optical imaging system of claim 1, wherein the second lens group further comprises a sixth lens disposed on an image-side surface of the fifth lens.

9. The optical imaging system of claim 8, wherein an object-side surface of the sixth lens has a concave shape.

10. An optical imaging system comprising:
a first lens having positive refractive power;
a second lens having refractive power;
a third lens having an image-side surface having a concave shape;
a fourth lens having refractive power;
a fifth lens having refractive power; and
an optical path folding member disposed between the first lens and the second lens,
wherein the first to fifth lenses are sequentially disposed from an object side, and
wherein the following condition is satisfied:
$$3. < D 12 / ( T 1 + T 2 ) < 4.0 ,$$
where D12 is a distance from an image-side surface of the first lens to an object-side surface of the second lens, T1 is a thickness of the first lens, and T2 is a thickness of the second lens.

11. The optical imaging system of claim 10, wherein an object-side surface of the first lens has a convex shape.

12. The optical imaging system of claim 10, wherein an object-side surface of the second lens has a convex shape.

13. The optical imaging system of claim 10, wherein an object-side surface of the third lens has a convex shape.

14. The optical imaging system of claim 10, wherein an object-side surface of the fourth lens has a convex shape.

15. The optical imaging system of claim 10, wherein an object-side surface of the fifth lens has a convex shape.

16. The optical imaging system of claim 10, wherein an object-side surface of the fifth lens has a concave shape.
